(19) United States
(12) Patent Application Publication
(10) Pub. No.: US 2025/0363710 A1
(43) Pub. Date: Nov. 27, 2025

(54) CONCURRENT EXECUTION OF DEPTH SURFACES IN GRAPHICS PROCESSING

(71) Applicant: QUALCOMM Incorporated, San Diego, CA (US)

(72) Inventors: Xuefeng TANG, San Diego, CA (US); Jian LIANG, San Diego, CA (US); Andrew Evan GRUBER, Arlington, MA (US); Nilesh SHAH, San Diego, CA (US); Kevin MATLAGE, Erie, CO (US); Srihari Babu ALLA, San Diego, CA (US); Jonnala Gadda NAGENDRA KUMAR, San Diego, CA (US); Ruohong ZHOU, Sunnyvale, CA (US); Vishwanath Shashikant NIKAM, Bangalore (IN); Kalyan Kumar BHIRAVABHATLA, Bengaluru (IN); Nigel POOLE, West Newton, MA (US); Shangmei YU, Sunnyvale, CA (US); Ruobai FENG, San Diego, CA (US); Tao WANG, Sunnyvale, CA (US); Girraj PAHARIYA, Bangalore (IN); Sharad RAJ, Bengaluru (IN)

(21) Appl. No.: 18/674,764

(22) Filed: May 24, 2024

(51) Int. Cl. G06T 15/00; G06T 15/40

(52) U.S. Cl. CPC G06T 15/005; G06T 15/405

(57) ABSTRACT

Aspects presented herein relate to methods and devices for graphics processing including an apparatus, e.g., a GPU. The apparatus may obtain an indication of a set of workloads. The apparatus may also assign a first subset of the set of workloads to a first graphics pipeline and a second subset of the set of workloads to a second graphics pipeline. Further, the apparatus may render the first subset of the set of workloads in the first graphics pipeline and the second subset of the set of workloads in the second graphics pipeline.

### TECHNICAL FIELD

The present disclosure relates generally to processing systems and, more particularly, to one or more techniques for graphics processing.

### INTRODUCTION

Computing devices often perform graphics and/or display processing (e.g., utilizing a graphics processing unit (GPU), a central processing unit (CPU), a display processor, etc.) to render and display visual content. Such computing devices may include, for example, computer workstations, mobile phones such as smartphones, embedded systems, personal computers, tablet computers, and video game consoles. GPUs are configured to execute a graphics processing pipeline that includes one or more processing stages, which operate together to execute graphics processing commands and output a frame. A central processing unit (CPU) may control the operation of the GPU by issuing one or more graphics processing commands to the GPU. Modern day CPUs are typically capable of executing multiple applications concurrently, each of which may need to utilize the GPU during execution. A display processor is configured to convert digital information received from a CPU to analog values and may issue commands to a display panel for displaying the visual content. A device that provides content for visual presentation on a display may utilize a GPU and/or a display processor.

A graphics processor of a device may be configured to perform the processes in a graphics processing pipeline. Further, graphics processors may utilize a number of different operations for depth surfaces. However, there has developed a need for improved depth surface operations.

### BRIEF SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

In an aspect of the disclosure, a method, a computer-readable medium, and an apparatus are provided. The apparatus may be a graphics processing unit (GPU), a central processing unit (CPU), or any apparatus that may perform for graphics processing. The apparatus may obtain an indication of a set of workloads. The apparatus may also assign a first subset of the set of workloads to a first graphics pipeline and a second subset of the set of workloads to a second graphics pipeline. Additionally, the apparatus may allocate a first resource for the first subset of the set of workloads and a second resource for the second subset of the set of workloads; and store first data associated with the first subset of the set of workloads in the first resource and second data associated with the second subset of the set of workloads in the second resource. The apparatus may also determine that at least one of (1) a portion of the first subset of the set of workloads is not to be rendered by the first graphics pipeline or (2) a portion of the second subset of the set of workloads is not to be rendered by the second graphics pipeline, where a change of assignment is based on the determination. Moreover, the apparatus may change an assignment of at least one of (1) a portion of the first subset of the set of workloads to the second graphics pipeline or (2) a portion of the second subset of the set of workloads to the first graphics pipeline. The apparatus may also output an indication of the change of assignment of at least one of (1) the portion of the first subset of the set of workloads to the second graphics pipeline or (2) the portion of the second subset of the set of workloads to the first graphics pipeline. The apparatus may also determine that at least one of (1) a portion of the first subset of the set of workloads has already been rendered in the second graphics pipeline or (2) a portion of the second subset of the set of workloads has already been rendered in the first graphics pipeline; and refrain from rendering at least one of (1) the portion of the first subset of the set of workloads or (2) the portion of the second subset of the workloads in the second graphics pipeline based on the determination. Further, the apparatus may render the first subset of the set of workloads in the first graphics pipeline and the second subset of the set of workloads in the second graphics pipeline. The apparatus may also output an indication of the rendered first subset of the set of workloads and the rendered second subset of the set of workloads.

The details of one or more examples of the disclosure are set forth in the accompanying drawings and the description below. Other features, objects, and advantages of the disclosure will be apparent from the description and drawings, and from the claims.

### BRIEF DESCRIPTION OF DRAWINGS

FIG. 1 is a block diagram that illustrates an example content generation system in accordance with one or more techniques of this disclosure.

FIG. 2 illustrates an example graphics processing unit (GPU) in accordance with one or more techniques of this disclosure.

FIG. 3 is a diagram illustrating example processing components in accordance with one or more techniques of this disclosure.

FIG. 4 is a diagram illustrating an example GPU hardware in accordance with one or more techniques of this disclosure.

FIG. 5 is a diagram illustrating an example GPU in accordance with one or more techniques of this disclosure.

FIG. 6 is a diagram illustrating an example GPU in accordance with one or more techniques of this disclosure.

FIG. 7 is a diagram illustrating an example depth pass operation in accordance with one or more techniques of this disclosure.

FIG. 8 is a diagram illustrating an example depth pass operation in accordance with one or more techniques of this disclosure.

FIG. 9 is a diagram illustrating an example depth pass workload distribution in accordance with one or more techniques of this disclosure.

FIG. 10 is a diagram illustrating an example depth pass operation in accordance with one or more techniques of this disclosure.

FIG. 11 is a diagram illustrating an example GPU in accordance with one or more techniques of this disclosure.

FIG. 12 is a diagram illustrating an example dataflow for depth pass operations in accordance with one or more techniques of this disclosure.

FIG. 13 is a communication flow diagram illustrating example communications between a GPU, a GPU component, and a memory in accordance with one or more techniques of this disclosure.

FIG. 14 is a flowchart of an example method of graphics processing in accordance with one or more techniques of this disclosure.

FIG. 15 is a flowchart of an example method of graphics processing in accordance with one or more techniques of this disclosure.

### DETAILED DESCRIPTION

In some instances, the amount of GPU hardware utilization may be reduced or low for some types of draws or surfaces, such as depth-only passes or Z-only passes. During depth-only or Z-only passes, the GPU may just render to a depth buffer or Z-buffer. That is, during depth-only or Z-only passes, there may not be any other types of buffer rendering (e.g., color buffer rendering). Z-only passes may have a low GPU utilization along with high memory bandwidth demand, such as in binning passes. In some types of applications or games, a decent amount of GPU time may be spent on depth-only or Z-only surfaces, which includes shadow draws or pre-Z draws. However, there may be a reduced amount of pixel shader workloads that correspond to these depth-only surfaces. The GPU utilization of these types of draws may be reduced or low because they have little or no pixel shader workload. Therefore, GPU hardware utilization may be reduced or low when executing certain types of surfaces (e.g., depth-only or Z-only surfaces). Aspects of the present disclosure may allow a GPU to elect a workload distribution scheme when the GPU hardware is not fully utilized.

Aspects of the present disclosure may include a number of benefits or advantages. For instance, aspects of the present disclosure may allow a GPU to elect a workload distribution scheme when the GPU hardware is not fully utilized. Aspects of the present disclosure may allow a GPU to elect a workload distribution scheme when executing certain types of surfaces (e.g., depth-only or Z-only surfaces). That is, aspects presented herein may allow a GPU to move certain workloads to separate and/or additional hardware pipelines. For example, aspects presented herein may allow a GPU to move certain workloads (e.g., depth-only or Z-only workloads) to additional hardware pipelines (e.g., binning render (BR) pipeline and/or a binning visibility (BV) pipeline). In one example, aspects presented herein may move the execution of workloads (e.g., depth-only or Z-only workloads) from solely a BR pipeline to both a BV pipeline and a BR pipeline. After moving the workloads to separate and/or additional hardware pipelines, aspects presented herein may allow the workloads to run concurrently with other workloads. The concurrent execution of workloads (e.g., depth-only or Z-only workloads) may allow a GPU to balance its workloads, so the GPU hardware can be utilized more efficiently. Indeed, aspects presented herein may also a GPU to balance workloads to in order to achieve more concurrency and better utilize the GPU resources.

Various aspects of systems, apparatuses, computer program products, and methods are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of this disclosure to those skilled in the art. Based on the teachings herein one skilled in the art should appreciate that the scope of this disclosure is intended to cover any aspect of the systems, apparatuses, computer program products, and methods disclosed herein, whether implemented independently of, or combined with, other aspects of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. Any aspect disclosed herein may be embodied by one or more elements of a claim.

Although various aspects are described herein, many variations and permutations of these aspects fall within the scope of this disclosure. Although some potential benefits and advantages of aspects of this disclosure are mentioned, the scope of this disclosure is not intended to be limited to particular benefits, uses, or objectives. Rather, aspects of this disclosure are intended to be broadly applicable to different wireless technologies, system configurations, networks, and transmission protocols, some of which are illustrated by way of example in the figures and in the following description. The detailed description and drawings are merely illustrative of this disclosure rather than limiting, the scope of this disclosure being defined by the appended claims and equivalents thereof.

Several aspects are presented with reference to various apparatus and methods. These apparatus and methods are described in the following detailed description and illustrated in the accompanying drawings by various blocks, components, circuits, processes, algorithms, and the like (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors (which may also be referred to as processing units). Examples of processors include microprocessors, microcontrollers, graphics processing units (GPUs), general purpose GPUs (GPGPUs), central processing units (CPUs), application processors, digital signal processors (DSPs), reduced instruction set computing (RISC) processors, systems-on-chip (SOC), baseband processors, application specific integrated circuits (ASICs), field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software may be construed broadly to mean instructions, instruction sets, code, code segments, program code, programs, subprograms, software components, applications, software applications, software packages, routines, subroutines, objects, executables, threads of execution, procedures, functions, etc., whether referred to as software, firmware, middleware, microcode, hardware description language, or otherwise. The term application may refer to software. As described herein, one or more techniques may refer to an application, i.e., software, being configured to perform one or more functions. In such examples, the application may be stored on a memory, e.g., on-chip memory of a processor, system memory, or any other memory. Hardware described herein, such as a processor may be configured to execute the application. For example, the application may be described as including code that, when executed by the hardware, causes the hardware to perform one or more techniques described herein. As an example, the hardware may access the code from a memory and execute the code accessed from the memory to perform one or more techniques described herein. In some examples, components are identified in this disclosure. In such examples, the components may be hardware, software, or a combination thereof. The components may be separate components or sub-components of a single component.

Accordingly, in one or more examples described herein, the functions described may be implemented in hardware, software, or any combination thereof. If implemented in software, the functions may be stored on or encoded as one or more instructions or code on a computer-readable medium. Computer-readable media includes computer storage media. Storage media may be any available media that may be accessed by a computer. By way of example, and not limitation, such computer-readable media may comprise a random access memory (RAM), a read-only memory (ROM), an electrically erasable programmable ROM (EEPROM), optical disk storage, magnetic disk storage, other magnetic storage devices, combinations of the aforementioned types of computer-readable media, or any other medium that may be used to store computer executable code in the form of instructions or data structures that may be accessed by a computer.

In general, this disclosure describes techniques for having a graphics processing pipeline in a single device or multiple devices, improving the rendering of graphical content, and/or reducing the load of a processing unit, i.e., any processing unit configured to perform one or more techniques described herein, such as a GPU. For example, this disclosure describes techniques for graphics processing in any device that utilizes graphics processing. Other example benefits are described throughout this disclosure.

As used herein, instances of the term “content” may refer to “graphical content,” “image,” and vice versa. This is true regardless of whether the terms are being used as an adjective, noun, or other parts of speech. In some examples, as used herein, the term “graphical content” may refer to a content produced by one or more processes of a graphics processing pipeline. In some examples, as used herein, the term “graphical content” may refer to a content produced by a processing unit configured to perform graphics processing. In some examples, as used herein, the term “graphical content” may refer to a content produced by a graphics processing unit. The term “workload” may refer to a graphics workload or any appropriate workload within graphics or display processing. The term “graphics pipeline” may refer to a pipeline within a graphics processor or a GPU, or any appropriate graphics processing component. For example, a graphics pipeline may refer to a binning render (BR) pipeline or a binning visibility (BV) pipeline within a GPU. The term “visibility stream” may refer to a stream within a GPU related to the visibility of object or primitives. The term “resource” may refer to a graphics resource or a resource at a graphics processor or GPU.

In some examples, as used herein, the term “display content” may refer to content generated by a processing unit configured to perform displaying processing. In some examples, as used herein, the term “display content” may refer to content generated by a display processing unit. Graphical content may be processed to become display content. For example, a graphics processing unit may output graphical content, such as a frame, to a buffer (which may be referred to as a framebuffer). A display processing unit may read the graphical content, such as one or more frames from the buffer, and perform one or more display processing techniques thereon to generate display content. For example, a display processing unit may be configured to perform composition on one or more rendered layers to generate a frame. As another example, a display processing unit may be configured to compose, blend, or otherwise combine two or more layers together into a single frame. A display processing unit may be configured to perform scaling, e.g., upscaling or downscaling, on a frame. In some examples, a frame may refer to a layer. In other examples, a frame may refer to two or more layers that have already been blended together to form the frame, i.e., the frame includes two or more layers, and the frame that includes two or more layers may subsequently be blended.

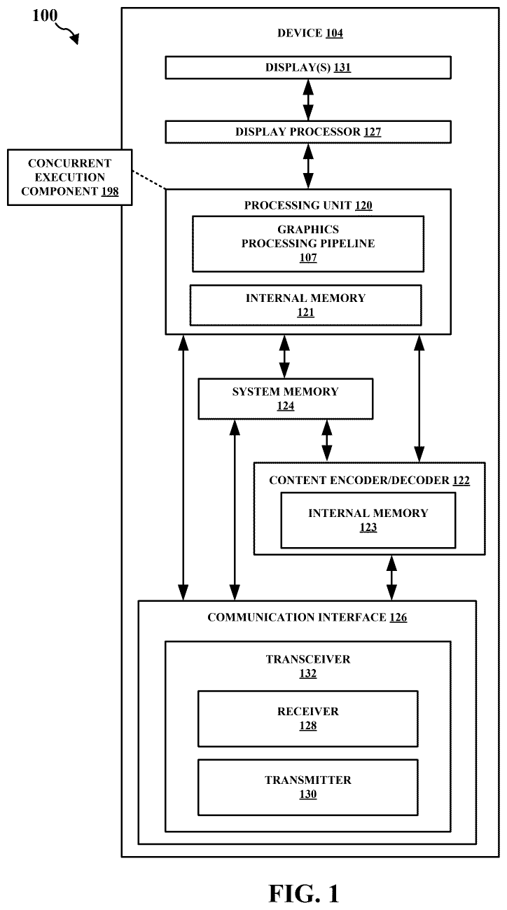

FIG. 1 is a block diagram that illustrates an example content generation system 100 configured to implement one or more techniques of this disclosure. The content generation system 100 includes a device 104. The device 104 may include one or more components or circuits for performing various functions described herein. In some examples, one or more components of the device 104 may be components of an SOC. The device 104 may include one or more components configured to perform one or more techniques of this disclosure. In the example shown, the device 104 may include a processing unit 120, a content encoder/decoder 122, and a system memory 124. In some aspects, the device 104 may include a number of components, e.g., a communication interface 126, a transceiver 132, a receiver 128, a transmitter 130, a display processor 127, and one or more displays 131. Reference to the display 131 may refer to the one or more displays 131. For example, the display 131 may include a single display or multiple displays. The display 131 may include a first display and a second display. The first display may be a left-eye display and the second display may be a right-eye display. In some examples, the first and second display may receive different frames for presentment thereon. In other examples, the first and second display may receive the same frames for presentment thereon. In further examples, the results of the graphics processing may not be displayed on the device, e.g., the first and second display may not receive any frames for presentment thereon. Instead, the frames or graphics processing results may be transferred to another device. In some aspects, this may be referred to as split-rendering.

The processing unit 120 may include an internal memory 121. The processing unit 120 may be configured to perform graphics processing, such as in a graphics processing pipeline 107. The content encoder/decoder 122 may include an internal memory 123. In some examples, the device 104 may include a display processor, such as the display processor 127, to perform one or more display processing techniques on one or more frames generated by the processing unit 120 before presentment by the one or more displays 131. The display processor 127 may be configured to perform display processing. For example, the display processor 127 may be configured to perform one or more display processing techniques on one or more frames generated by the processing unit 120. The one or more displays 131 may be configured to display or otherwise present frames processed by the display processor 127. In some examples, the one or more displays 131 may include one or more of: a liquid crystal display (LCD), a plasma display, an organic light emitting diode (OLED) display, a projection display device, an augmented reality display device, a virtual reality display device, a head-mounted display, or any other type of display device.

Memory external to the processing unit 120 and the content encoder/decoder 122, such as system memory 124, may be accessible to the processing unit 120 and the content encoder/decoder 122. For example, the processing unit 120 and the content encoder/decoder 122 may be configured to read from and/or write to external memory, such as the system memory 124. The processing unit 120 and the content encoder/decoder 122 may be communicatively coupled to the system memory 124 over a bus. In some examples, the processing unit 120 and the content encoder/decoder 122 may be communicatively coupled to each other over the bus or a different connection.

The content encoder/decoder 122 may be configured to receive graphical content from any source, such as the system memory 124 and/or the communication interface 126. The system memory 124 may be configured to store received encoded or decoded graphical content. The content encoder/decoder 122 may be configured to receive encoded or decoded graphical content, e.g., from the system memory 124 and/or the communication interface 126, in the form of encoded pixel data. The content encoder/decoder 122 may be configured to encode or decode any graphical content.

The internal memory 121 or the system memory 124 may include one or more volatile or non-volatile memories or storage devices. In some examples, internal memory 121 or the system memory 124 may include RAM, SRAM, DRAM, erasable programmable ROM (EPROM), electrically erasable programmable ROM (EEPROM), flash memory, a magnetic data media or an optical storage media, or any other type of memory.

The internal memory 121 or the system memory 124 may be a non-transitory storage medium according to some examples. The term “non-transitory” may indicate that the storage medium is not embodied in a carrier wave or a propagated signal. However, the term “non-transitory” should not be interpreted to mean that internal memory 121 or the system memory 124 is non-movable or that its contents are static. As one example, the system memory 124 may be removed from the device 104 and moved to another device. As another example, the system memory 124 may not be removable from the device 104.

The processing unit 120 may be a central processing unit (CPU), a graphics processing unit (GPU), a general purpose GPU (GPGPU), or any other processing unit that may be configured to perform graphics processing. In some examples, the processing unit 120 may be integrated into a motherboard of the device 104. In some examples, the processing unit 120 may be present on a graphics card that is installed in a port in a motherboard of the device 104, or may be otherwise incorporated within a peripheral device configured to interoperate with the device 104. The processing unit 120 may include one or more processors, such as one or more microprocessors, GPUs, application specific integrated circuits (ASICs), field programmable gate arrays (FPGAs), arithmetic logic units (ALUs), digital signal processors (DSPs), discrete logic, software, hardware, firmware, other equivalent integrated or discrete logic circuitry, or any combinations thereof. If the techniques are implemented partially in software, the processing unit 120 may store instructions for the software in a suitable, non-transitory computer-readable storage medium, e.g., internal memory 121, and may execute the instructions in hardware using one or more processors to perform the techniques of this disclosure. Any of the foregoing, including hardware, software, a combination of hardware and software, etc., may be considered to be one or more processors.

The content encoder/decoder 122 may be any processing unit configured to perform content decoding. In some examples, the content encoder/decoder 122 may be integrated into a motherboard of the device 104. The content encoder/decoder 122 may include one or more processors, such as one or more microprocessors, application specific integrated circuits (ASICs), field programmable gate arrays (FPGAs), arithmetic logic units (ALUs), digital signal processors (DSPs), video processors, discrete logic, software, hardware, firmware, other equivalent integrated or discrete logic circuitry, or any combinations thereof. If the techniques are implemented partially in software, the content encoder/decoder 122 may store instructions for the software in a suitable, non-transitory computer-readable storage medium, e.g., internal memory 123, and may execute the instructions in hardware using one or more processors to perform the techniques of this disclosure. Any of the foregoing, including hardware, software, a combination of hardware and software, etc., may be considered to be one or more processors.

In some aspects, the content generation system 100 may include a communication interface 126. The communication interface 126 may include a receiver 128 and a transmitter 130. The receiver 128 may be configured to perform any receiving function described herein with respect to the device 104. Additionally, the receiver 128 may be configured to receive information, e.g., eye or head position information, rendering commands, or location information, from another device. The transmitter 130 may be configured to perform any transmitting function described herein with respect to the device 104. For example, the transmitter 130 may be configured to transmit information to another device, which may include a request for content. The receiver 128 and the transmitter 130 may be combined into a transceiver 132. In such examples, the transceiver 132 may be configured to perform any receiving function and/or transmitting function described herein with respect to the device 104.

Referring again to FIG. 1, in certain aspects, the processing unit 120 may include a concurrent execution component 198 configured to obtain an indication of a set of workloads. The concurrent execution component 198 may also be configured to assign a first subset of the set of workloads to a first graphics pipeline and a second subset of the set of workloads to a second graphics pipeline. The concurrent execution component 198 may also be configured to allocate a first resource for the first subset of the set of workloads and a second resource for the second subset of the set of workloads; and store first data associated with the first subset of the set of workloads in the first resource and second data associated with the second subset of the set of workloads in the second resource. The concurrent execution component 198 may also be configured to determine that at least one of (1) a portion of the first subset of the set of workloads is not to be rendered by the first graphics pipeline or (2) a portion of the second subset of the set of workloads is not to be rendered by the second graphics pipeline, where a change of assignment is based on the determination. The concurrent execution component 198 may also be configured to change an assignment of at least one of (1) a portion of the first subset of the set of workloads to the second graphics pipeline or (2) a portion of the second subset of the set of workloads to the first graphics pipeline. The concurrent execution component 198 may also be configured to output an indication of the change of assignment of at least one of (1) the portion of the first subset of the set of workloads to the second graphics pipeline or (2) the portion of the second subset of the set of workloads to the first graphics pipeline. The concurrent execution component 198 may also be configured to determine that at least one of (1) a portion of the first subset of the set of workloads has already been rendered in the second graphics pipeline or (2) a portion of the second subset of the set of workloads has already been rendered in the first graphics pipeline; and refrain from rendering at least one of (1) the portion of the first subset of the set of workloads or (2) the portion of the second subset of the workloads in the second graphics pipeline based on the determination. The concurrent execution component 198 may also be configured to render the first subset of the set of workloads in the first graphics pipeline and the second subset of the set of workloads in the second graphics pipeline. The concurrent execution component 198 may also be configured to output an indication of the rendered first subset of the set of workloads and the rendered second subset of the set of workloads. Although the following description may be focused on graphics processing, the concepts described herein may be applicable to other similar processing techniques.

As described herein, a device, such as the device 104, may refer to any device, apparatus, or system configured to perform one or more techniques described herein. For example, a device may be a server, a base station, user equipment, a client device, a station, an access point, a computer, e.g., a personal computer, a desktop computer, a laptop computer, a tablet computer, a computer workstation, or a mainframe computer, an end product, an apparatus, a phone, a smart phone, a server, a video game platform or console, a handheld device, e.g., a portable video game device or a personal digital assistant (PDA), a wearable computing device, e.g., a smart watch, an augmented reality device, or a virtual reality device, a non-wearable device, a display or display device, a television, a television set-top box, an intermediate network device, a digital media player, a video streaming device, a content streaming device, an in-car computer, any mobile device, any device configured to generate graphical content, or any device configured to perform one or more techniques described herein. Processes herein may be described as performed by a particular component (e.g., a GPU), but, in further embodiments, may be performed using other components (e.g., a CPU), consistent with disclosed embodiments.

GPUs may process multiple types of data or data packets in a GPU pipeline. For instance, in some aspects, a GPU may process two types of data or data packets, e.g., context register packets and draw call data. A context register packet may be a set of global state information, e.g., information regarding a global register, shading program, or constant data, which may regulate how a graphics context will be processed. For example, context register packets may include information regarding a color format. In some aspects of context register packets, there may be a bit that indicates which workload belongs to a context register. Also, there may be multiple functions or programming running at the same time and/or in parallel. For example, functions or programming may describe a certain operation, e.g., the color mode or color format. Accordingly, a context register may define multiple states of a GPU.

Context states may be utilized to determine how an individual processing unit functions, e.g., a vertex fetcher (VFD), a vertex shader (VS), a shader processor, or a geometry processor, and/or in what mode the processing unit functions. In order to do so, GPUs may use context registers and programming data. In some aspects, a GPU may generate a workload (e.g., a vertex or pixel workload) in the pipeline based on the context register definition of a mode or state. Certain processing units, e.g., a VFD, may use these states to determine certain functions, e.g., how a vertex is assembled. As these modes or states may change, GPUs may need to change the corresponding context. Additionally, the workload that corresponds to the mode or state may follow the changing mode or state.

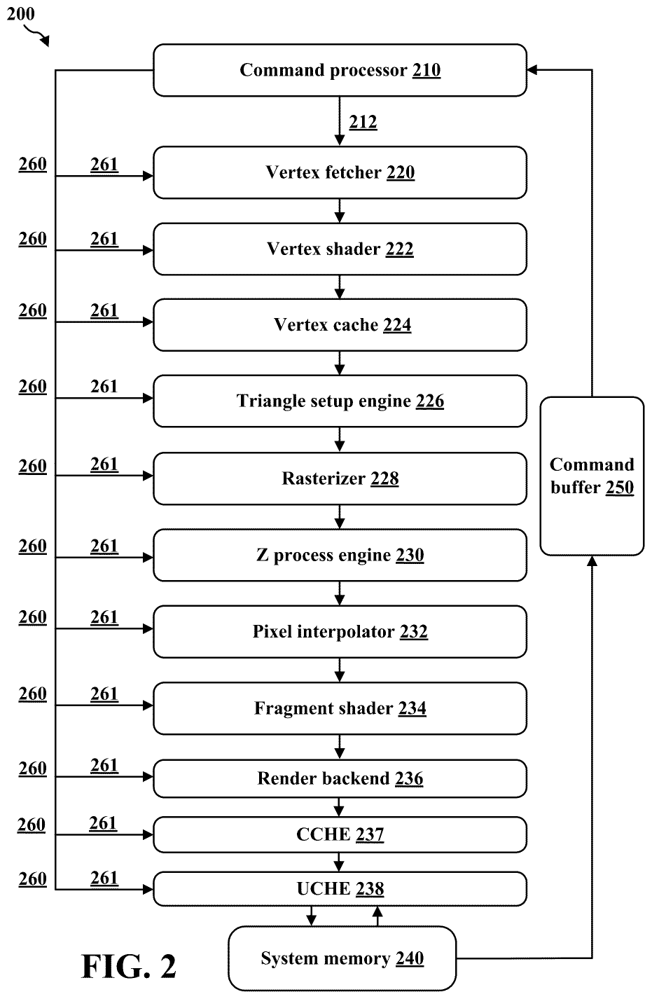

FIG. 2 illustrates an example GPU 200 in accordance with one or more techniques of this disclosure. As shown in FIG. 2, GPU 200 includes command processor (CP) 210, draw call packets 212, VFD 220, VS 222, vertex cache (VPC) 224, triangle setup engine (TSE) 226, rasterizer (RAS) 228, Z process engine (ZPE) 230, pixel interpolator (PI) 232, fragment shader (FS) 234, render backend (RB) 236, level 1 (L1) cache (cluster cache (CCHE)) 237, level 2 (L2) cache (UCHE) 238, and system memory 240. Although FIG. 2 displays that GPU 200 includes processing units 220-238, GPU 200 may include a number of additional processing units. Additionally, processing units 220-238 are merely an example and any combination or order of processing units may be used by GPUs according to the present disclosure. GPU 200 also includes command buffer 250, context register packets 260, and context states 261.

As shown in FIG. 2, a GPU may utilize a CP, e.g., CP 210, or hardware accelerator to parse a command buffer into context register packets, e.g., context register packets 260, and/or draw call data packets, e.g., draw call packets 212. The CP 210 may then send the context register packets 260 or draw call packets 212 through separate paths to the processing units or blocks in the GPU. Further, the command buffer 250 may alternate different states of context registers and draw calls. For example, a command buffer may be structured in the following manner: context register of context N, draw call(s) of context N, context register of context N+1, and draw call(s) of context N+1.

GPUs may render images in a variety of different ways. In some instances, GPUs may render an image using rendering and/or tiled rendering. In tiled rendering GPUs, an image may be divided or separated into different sections or tiles. After the division of the image, each section or tile may be rendered separately. Tiled rendering GPUs may divide computer graphics images into a grid format, such that each portion of the grid, i.e., a tile, is separately rendered. In some aspects, during a binning pass, an image may be divided into different bins or tiles. In some aspects, during the binning pass, a visibility stream may be constructed where visible primitives or draw calls may be identified. In contrast to tiled rendering, direct rendering does not divide the frame into smaller bins or tiles. Rather, in direct rendering, the entire frame is rendered at a single time. Additionally, some types of GPUs may allow for both tiled rendering and direct rendering.

Instructions executed by a CPU (e.g., software instructions) or a display processor may cause the CPU or the display processor to search for and/or generate a composition strategy for composing a frame based on a dynamic priority and runtime statistics associated with one or more composition strategy groups. A frame to be displayed by a physical display device, such as a display panel, may include a plurality of layers. Also, composition of the frame may be based on combining the plurality of layers into the frame (e.g., based on a frame buffer). After the plurality of layers are combined into the frame, the frame may be provided to the display panel for display thereon. The process of combining each of the plurality of layers into the frame may be referred to as composition, frame composition, a composition procedure, a composition process, or the like.

A frame composition procedure or composition strategy may correspond to a technique for composing different layers of the plurality of layers into a single frame. The plurality of layers may be stored in doubled data rate (DDR) memory. Each layer of the plurality of layers may further correspond to a separate buffer. A composer or hardware composer (HWC) associated with a block or function may determine an input of each layer/buffer and perform the frame composition procedure to generate an output indicative of a composed frame. That is, the input may be the layers and the output may be a frame composition procedure for composing the frame to be displayed on the display panel.

Some types of GPUs may include different types of pipelines, such as a graphics processing pipeline. Graphics processing pipelines may include one or more of a vertex shader stage, a hull shader stage, a domain shader stage, a geometry shader stage, and a pixel shader stage. These stages of the graphics processing pipeline may be considered shader stages. These shader stages may be implemented as one or more shader programs that execute on shader units at a GPU. Shader units may be configured as a programmable pipeline of processing components. In some examples, a shader unit may be referred to as “shader processors” or “unified shaders,” and may perform geometry, vertex, pixel, or other shading operations to render graphics. Shader units may include shader processors, each of which may include one or more components for fetching and decoding operations, one or more arithmetic logic units (ALUs) for carrying out arithmetic calculations, one or more memories, caches, and registers.

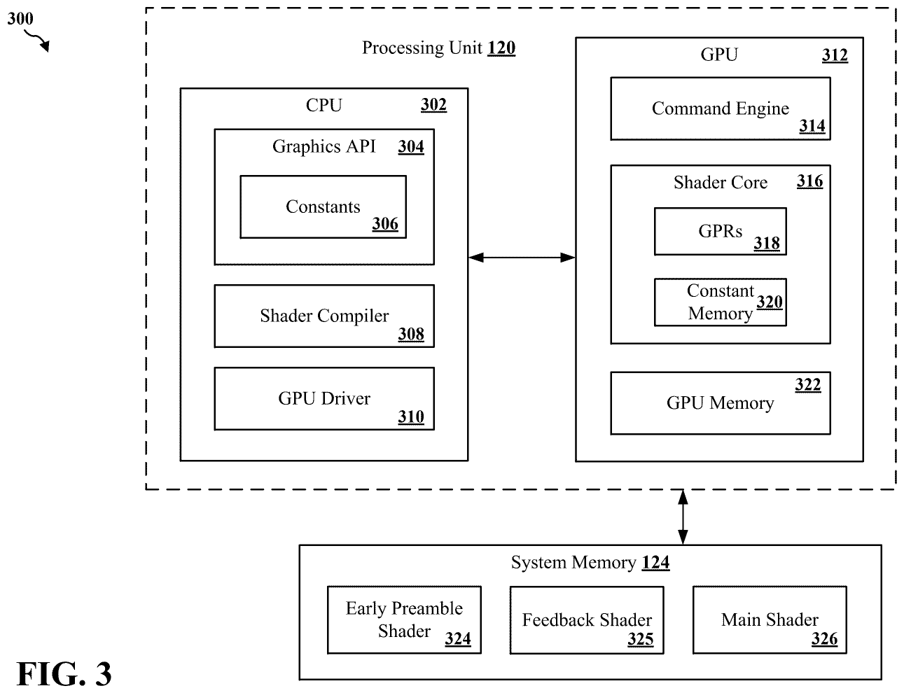

FIG. 3 is a diagram 300 that illustrates processing components, such as the processing unit 120 and the system memory 124, as may be identified in connection with the device 104 for processing data. In aspects, the processing unit 120 may include a CPU 302 and a GPU 312. The GPU 312 and the CPU 302 may be formed as an integrated circuit (e.g., a system-on-a-chip (SOC)) and/or the GPU 312 may be incorporated onto a motherboard with the CPU 302. Alternatively, the CPU 302 and the GPU 312 may be configured as distinct processing units that are communicatively coupled to each other. For example, the GPU 312 may be incorporated on a graphics card that is installed in a port of the motherboard that includes the CPU 302.

The CPU 302 may be configured to execute a software application that causes graphical content to be displayed (e.g., on the display(s) 131 of the device 104) based on one or more operations of the GPU 312. The software application may issue instructions to a graphics application program interface (API) 304, which may be a runtime program that translates instructions received from the software application into a format that is readable by a GPU driver 310. After receiving instructions from the software application via the graphics API 304, the GPU driver 310 may control an operation of the GPU 312 based on the instructions. For example, the GPU driver 310 may generate one or more command streams that are placed into the system memory 124, where the GPU 312 is instructed to execute the command streams (e.g., via one or more system calls). A command engine 314 included in the GPU 312 is configured to retrieve the one or more commands stored in the command streams. The command engine 314 may provide commands from the command stream for execution by the GPU 312. The command engine 314 may be hardware of the GPU 312, software/firmware executing on the GPU 312, or a combination thereof. While the GPU driver 310 is configured to implement the graphics API 304, the GPU driver 310 is not limited to being configured in accordance with any particular API. The system memory 124 may store the code for the GPU driver 310, which the CPU 302 may retrieve for execution. In examples, the GPU driver 310 may be configured to allow communication between the CPU 302 and the GPU 312, such as when the CPU 302 offloads graphics or non-graphics processing tasks to the GPU 312 via the GPU driver 310.

The system memory 124 may further store source code for one or more of an early preamble shader 324, a feedback shader 325, or a main shader 326. In such configurations, a shader compiler 308 executing on the CPU 302 may compile the source code of the shaders 324-326 to create object code or intermediate code executable by a shader core 316 of the GPU 312 during runtime (e.g., at the time when the shaders 324-326 are to be executed on the shader core 316). In some examples, the shader compiler 308 may pre-compile the shaders 324-326 and store the object code or intermediate code of the shader programs in the system memory 124. The shader compiler 308 (or in another example the GPU driver 310) executing on the CPU 302 may build a shader program with multiple components including the early preamble shader 324, the feedback shader 325, and the main shader 326. The main shader 326 may correspond to a portion or the entirety of the shader program that does not include the early preamble shader 324 or the feedback shader 325. The shader compiler 308 may receive instructions to compile the shader(s) 324-326 from a program executing on the CPU 302. The shader compiler 308 may also identify constant load instructions and common operations in the shader program for including the common operations within the early preamble shader 324 (rather than the main shader 326). The shader compiler 308 may identify such common instructions, for example, based on (presently undetermined) constants 306 to be included in the common instructions. The constants 306 may be defined within the graphics API 304 to be constant across an entire draw call. The shader compiler 308 may utilize instructions such as a preamble shader start to indicate a beginning of the early preamble shader 324 and a preamble shader end to indicate an end of the early preamble shader 324. Similar instructions may be used for the feedback shader 325 and the main shader 326. The feedback shader 325 will be described in further detail below.

The shader core 316 included in the GPU 312 may include general purpose registers (GPRs) 318 and constant memory 320. The GPRs 318 may correspond to a single GPR, a GPR file, and/or a GPR bank. Each GPR in the GPRs 318 may store data accessible to a single thread. The software and/or firmware executing on GPU 312 may be a shader program 324-326, which may execute on the shader core 316 of GPU 312. The shader core 316 may be configured to execute many instances of the same instructions of the same shader program in parallel. For example, the shader core 316 may execute the main shader 326 for each pixel that defines a given shape. The shader core 316 may transmit and receive data from applications executing on the CPU 302. In examples, constants 306 used for execution of the shaders 324-326 may be stored in a constant memory 320 (e.g., a read/write constant RAM) or the GPRs 318. The shader core 316 may load the constants 306 into the constant memory 320. In further examples, execution of the early preamble shader 324 or the feedback shader 325 may cause a constant value or a set of constant values to be stored in on-chip memory such as the constant memory 320 (e.g., constant RAM), the GPU memory 322, or the system memory 124. The constant memory 320 may include memory accessible by all aspects of the shader core 316 rather than just a particular portion reserved for a particular thread such as values held in the GPRs 318.

In some aspects, different types of GPU hardware may support different types of workload execution. For instance, GPU hardware may support concurrent execution of different workloads. Concurrent execution may refer to the simultaneous execution of workloads at a GPU. Also, concurrent execution may refer to the execution of workloads in parallel at a GPU. GPU hardware may also support concurrent execution of different workloads in a time-shared manner. In some instances, concurrent execution of different workloads in a time-shared manner may improve the performance per area at the GPU. However, in other instances, concurrent execution of different workloads in a time-shared manner may reduce the performance per area at the GPU. Additionally, different types of workloads may take a different amount of processing time in various stages of the GPU pipeline. Also, these types of workloads may introduce inefficiency in GPU hardware utilization.

In some aspects, scheduling algorithms in order to time-share the GPU hardware may sequence the workload to achieve the best utilization of GPU hardware. However, some types of workloads may block the execution of other successive workloads. For instance, some workloads with a higher specification for a resource (e.g., memory access latency) may block the execution of other successive workloads, which may have reduced resource specification and a faster execution time (e.g., head of line blocking). In turn, this may reduce the overall hardware efficiency at the GPU. This kind of workload pattern is common in certain types of binning (e.g., concurrent binning). For example, in concurrent binning, a tile sorting pass for a certain frame (e.g., frame ‘N+1’) may be run concurrently with a rendering pass of another frame (e.g., frame ‘N’).

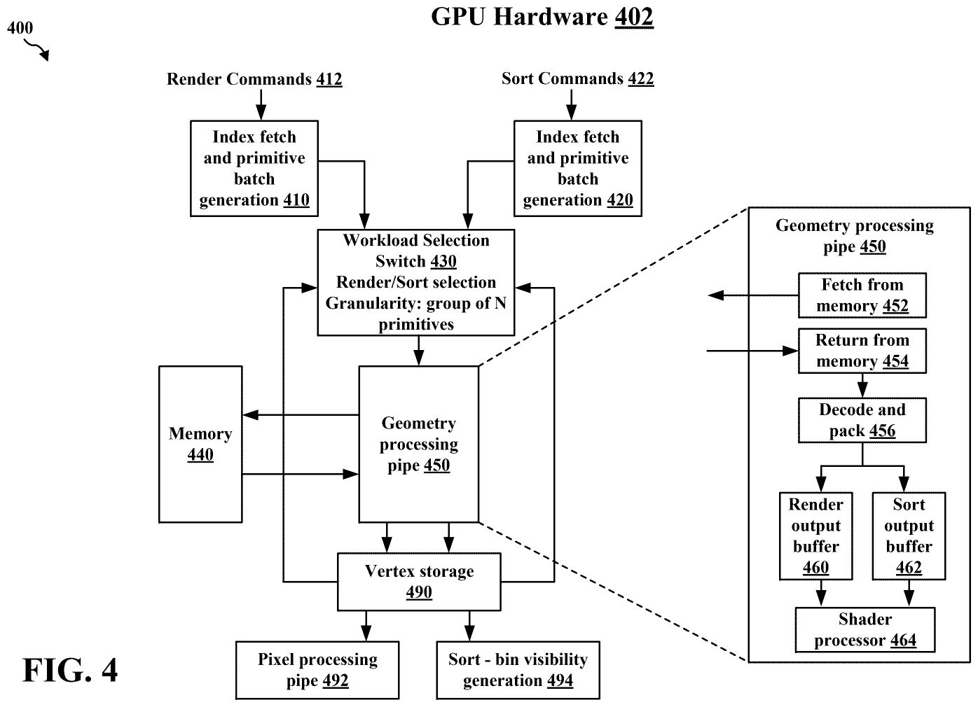

FIG. 4 illustrates diagram 400 including one example of GPU hardware. More specifically, diagram 400 depicts a time-shared GPU hardware for concurrent binning. As shown in FIG. 4, diagram 400 includes GPU hardware 402 including index fetch and primitive batch generation component 410, index fetch and primitive batch generation component 420, software 430, memory 440, geometry processing pipe 450, vertex storage component 490, pixel processing pipe 492, and sort-bin visibility generation component 494. As shown in FIG. 4, render commands 412 may be input to index fetch and primitive batch generation component 410, which may be output to software 430. Similarly, sort commands 422 may be input to index fetch and primitive batch generation component 420, which may be output to software 430. The software 430 may have a render/sort selection capability, as well as a certain granularity (e.g., a granularity for a group of N primitives). The output of software 430 may be sent to geometry processing pipe 450, which may communicate with memory 440. The geometry processing pipe 450 may include fetch from memory component 452, return from memory component 454, decode and pack component 456, render output buffer 460, sort output buffer 462, and shader processor 464. Also, the output of geometry processing pipe 450 may be sent to vertex storage component 490, which may be sent to pixel processing pipe 492 and sort-bin visibility generation component 494.

As shown in FIG. 4, geometry pipe hardware (e.g., geometry processing pipe 450) may be time shared between tile sorting and tile render workloads. Also, a scheduling algorithm (e.g., software 430) may consider the availability of GPU hardware for tile sorting and tile render workload. The granularity of a workload may be selected such that there is limited workload switching overhead. Further, the granularity of a workload may be selected such that, at the same time, one workload does not block the other. As shown in FIG. 4, the software 430 may have a granularity of a group of N primitives. For instance, for concurrent binning, the workload distribution granularity may be a primitive batch (e.g., a set of N primitives).

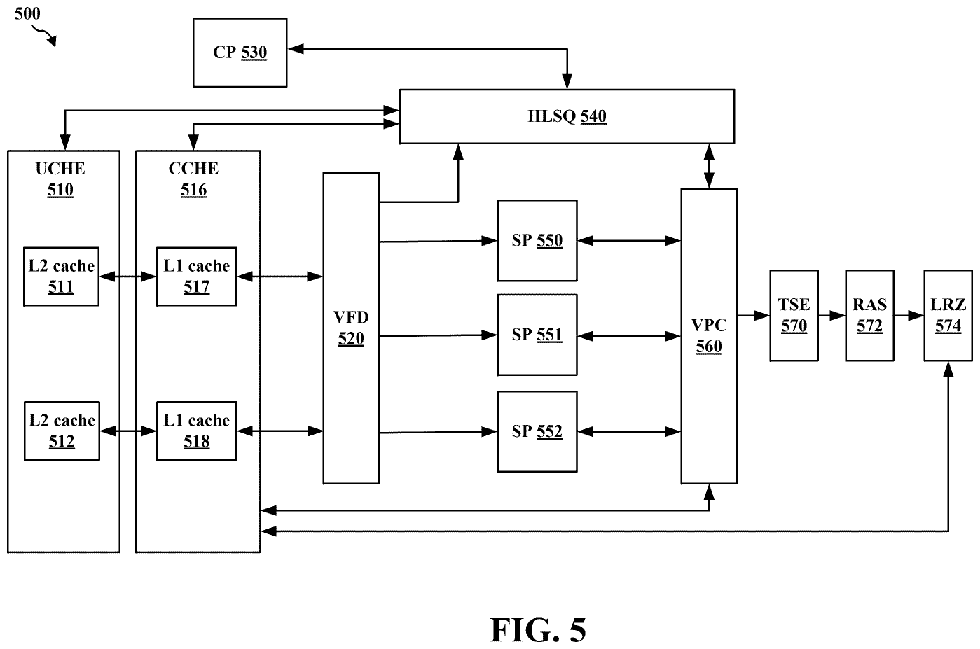

FIG. 5 is a diagram illustrating another example GPU. More specifically, FIG. 5 depicts GPU 500 including a number of different components. As shown in FIG. 5, GPU 500 includes UCHE 510 including L2 cache 511 and L2 cache 512, CCHE 516 including L1 cache 517 and L1 cache 518, VFD 520, CP 530, HLSQ 540, a number of SPs (e.g., SP 550, SP 551, and SP 552), VPC 560, TSE 570, RAS 572, and low resolution Z (LRZ) component (e.g., LRZ 574). As shown in FIG. 5, CP 530 may transmit data to HLSQ 540 and receive data from HLSQ 540. CCHE 516 may transmit/receive data to/from HLSQ 540. UCHE 510 may also transmit/receive data to/from HLSQ 540. L2 cache 511 and L2 cache 512 may transmit/receive data to/from VFD 520. Further, VFD 520 may transmit data to HLSQ 540, as well as transmit data to SPs 550-552. Moreover, SPs 550-552 may transmit/receive data to/from VPC 560. Also, VPC 560 may transmit/receive data to/from HLSQ 540. Data can also be transmitted from VPC 560 to TSE 570, which can transmit data to RAS 572, and then to LRZ 574. CCHE 516 can transmit/receive data to/from VPC 560 and LRZ 574. Also, UCHE 510 can transmit/receive data to/from VPC 560 and LRZ 574.

Some aspects of graphics processing may utilize certain GPU architectures and/or application structures. For instance, aspects of graphics processing may utilize a general purpose GPU (GPGPU) architecture that includes symmetric multiprocessor (SMs), shared cores, an interconnect unit, a dynamic random access memory (DRAM), and/or a number of different caches (e.g., a first level (L1) cache, a second level (L2) cache, and/or a last level cache (LLC)). In some instances of GPU architectures, a number of SMs, shared cores, and L1 caches may be connected to an interconnect unit. The interconnect unit may be connected to L2 caches and DRAMs. Additionally, in an application structure, an application may include a number of kernels, and each of the kernels may include concurrent thread arrays (CTAs), where each CTA includes a number of warps.

As indicated herein, a kernel may be a programming operations manager or a programming thread at a GPU. Also, a kernel may be executed in parallel by an array of threads, where all threads may run the same code. Each thread may have an identifier (ID) that it uses to compute memory addresses and make control decisions. A warp may be a collection of threads (e.g., 32 threads) that are executed simultaneously by a symmetric multiprocessor (SM). A warp may be a basic unit of execution, where multiple warps may be executed on an SM at once. When a program on a CPU invokes a kernel grid, the blocks of the grid may be enumerated and distributed to SMs with available execution capacity. The threads of a thread block may execute concurrently on one SM, and multiple thread blocks may execute concurrently on one SM. As thread blocks terminate, new blocks are launched on the vacated SMs. The mapping between warps and thread blocks may affect the performance of the kernel. Also, a clock or GPU clock may be a logical beat or time that is used to synchronize actions of the GPU. A clock source may manage how a GPU component derives its clock. A symmetric multiprocessor (SM) may be single instruction multiple thread processor which has multiple shared cores (e.g., shader processors (SPs)) for integer processing, special functional units (SFUs) (e.g., for calculating functions such as sine, cosine, root mean-squared (RMS), etc.). The SM may have load store (LD/ST) units for load and store into memory/registers. The SM may also have L1 caches, shared caches and large-banked register files. A concurrent thread array (CTA) may be a basic workload unit assigned to an SM in a GPU. Threads in a CTA may be sub-grouped into a warp/wavefronts, which is the smallest execution unit sharing the same program counter. A last level cache (LLC) may be a last level of cache from a GPUs context, such as an extended cache for SMs. An interconnect unit may be a crossbar switch which does multi-master arbitration, by which GPUs are connected to rest of the world. Further, a pointer of serialization/pointer of coherence (PoS/PoC) may be point in the system-on-chip (SoC) post where every master in the system may see the same coherent copy of data.

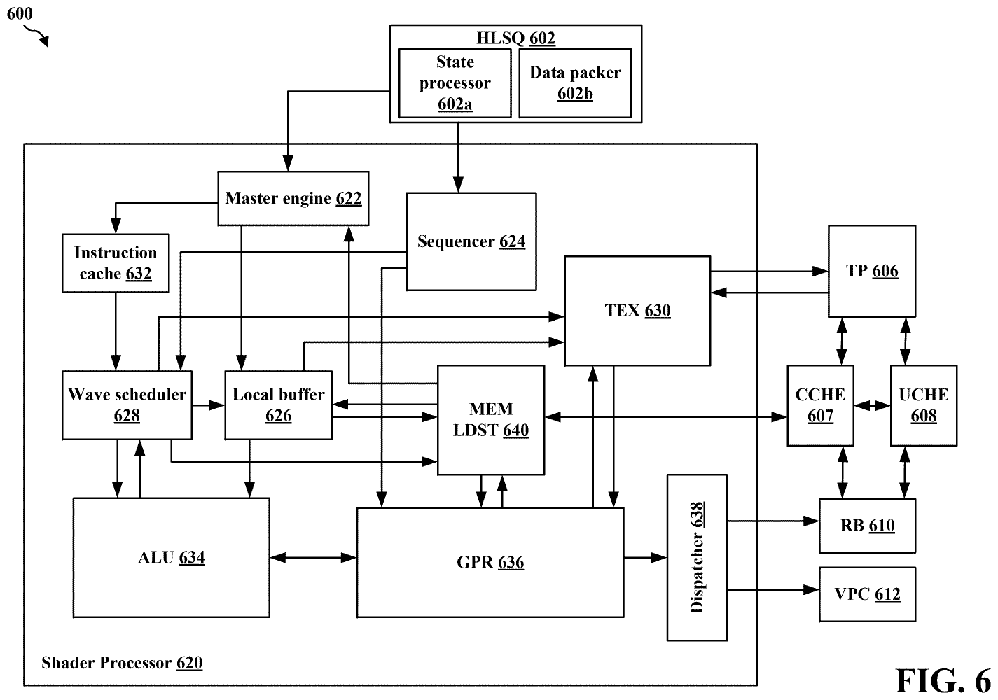

FIG. 6 illustrates an example GPU 600. Specifically, FIG. 6 illustrates a shader processor (SP) system in GPU 600. As shown in FIG. 6, GPU 600 includes a high level sequencer (HLSQ) 602, texture processor (TP) 606, level 1 (L1) cache (cluster cache (CCHE)) 607, level 2 (L2) cache (UCHE) 608, render backend (RB) 610, and vertex cache (VPC) 612. GPU 600 also includes SP 620, master engine 622, sequencer 624, local buffer 626, wave scheduler 628, texture (TEX) 630, instruction cache 632, arithmetic logic unit (ALU) 634, GPR 636, dispatcher 638, and memory (MEM) load store (LDST) 640.

As shown in FIG. 6, each unit or block in GPU 600 may send data or information to other blocks. For instance, HLSQ 602 may send commands to the master engine 622. Also, HLSQ 602 may send vertex threads, vertex attributes, pixel threads, pixel attributes, and/or compute commands to the sequencer 624. TP 606 may receive texture requests from TEX 630, and send texture elements (texels) back to the TEX 630. Further, TP 606 may send memory read requests to and receive memory data from CCHE 607 or UCHE 608. CCHE 607 or UCHE 608 may also receive memory read or write requests from MEM LDST 640 and send memory data back to MEM LDST 640, as well as receive memory read or write requests from RB 610 and send memory data back to RB 610. Also, RB 610 may receive an output in the form of color from GPR 636, e.g., via dispatcher 638. VPC 612 may also receive output in the form of vertices from GPR 636, e.g., via dispatcher 638. GPR 636 may send address data or receive write back data from MEM LDST 640. GPR 636 may also send temporary data to and receive temporary data from ALU 634. Moreover, ALU 634 may send address or predicate information to the wave scheduler 628, as well as receive instructions from wave scheduler 628. Local buffer 626 may send constant data to ALU 634. TEX 630 may also receive texture attributes from or send texture data to GPR 636, as well as receive constant data from local buffer 626. Further, TEX 630 may receive texture requests from wave scheduler 628, as well as receive constant data from local buffer 626. MEM LDST 640 may send/receive constant data to/from local buffer 626. Sequencer 624 may send wave data to wave scheduler 628, as well as send data to GPR 636. The sequencer 624 may allocate resources and local memory. Also, the sequencer 624 may allocate wave slots and any associated GPR 636 space. For example, the sequencer 624 may allocate wave slots or GPR 636 space when the HLSQ 602 issues a pixel tile workload to the SP 620. Master engine 622 may send program data to instruction cache 632, as well as send constant data to local buffer 626 and receive instructions from MEM LDST 640. Instruction cache 632 may send instructions or decode information to wave scheduler 628. Wave scheduler 628 may send read requests to local buffer 626, as well as send memory requests to MEM LDST 640.

As further shown in FIG. 6, the HLSQ 602 may prepare one or more context states for the SP 620. For example, the HLSQ 602 may prepare the context states for different types of data, e.g., global register data, shader constant data, buffer descriptors, instructions, etc. Additionally, the HLSQ 602 may embed context states into a command stream to the SP 620. The master engine 622 may parse the command stream from the HLSQ 602 and setup an SP global state. Moreover, the master engine 622 may fill or add to an instruction cache 632 and/or a local buffer 626 or a constant buffer. In some aspects, inside the HLSQ 602, there may be an internal function unit called a state processor 602a. The state processor 602a may be a single fiber scalar processor that may execute a special shader program, e.g., a preamble shader. The preamble shader may be generated by the GPU compiler in order to load constant data from different buffer objects. Also, the preamble shader may bind the buffer objects into a single constant buffer, such as a post-process constant buffer. Further, the HLSQ 602 may execute the preamble shader and, as a result, skip utilizing a main shader. In some instances, the main shader may perform different shading tasks, such as normal vertex shading and/or a fragment shading program. Moreover, the HLSQ 602 may include a data packer 602b.

Additionally, as shown in FIG. 6, the SP 620 may not be limited to executing a preamble if the HLSQ 602 decides to skip a preamble execution. For instance, the SP 620 may also process a conventional graphics workload, such as vertex shading and/or fragment shading. In some aspects, the SP 620 may utilize its execution units and storage in order to process compute tasks as a general purpose GPU (GPGPU). Inside the SP 620, there may be multiple parallel instruction execution units such as an ALU, elementary function unit (EFU), branching unit, TEX, general memory read and write (aka LDST), etc. The SP 620 may also include on-chip storage memory, such as a GPR 636 which may store per-fiber private data. Also, the SP 620 may include a local buffer 626 which stores per-shader or per-kernel constant data, per-wave uniform data (aka uGPR), and per-compute work group (WG) local memory (LM). Processing a preamble shader may take up one wave slot. Further, the majority of preamble shaders may use just the uGPR and not the GPR, and may execute ALU instructions on a scalar ALU. Therefore, execution of the preamble shader may be associated with high performance, and may be power efficient because any available wave slot may be used to execute the preamble shader even without GPR space allocation.

Moreover, as shown in FIG. 6, dispatcher 638 may fetch data from GPR 636. Dispatcher 638 may also perform format conversion, and then dispatch a final color to multiple render targets (RTs). Each RT may have one or more components, such as red (r) green (G) blue (B) alpha (A) (RGBA) data, or just an alpha component of the RGBA data. Further, each RT may be generally stored in a vector GPR, i.e., R3.0 may store red data, R3.1 may store green data, R3.2 may store blue data, etc. Also, a driver program in an SP context register may be utilized to define the GPR identifier (ID) which stores RT data.

In some aspects, of graphics processing, graphics workloads may rely on depth passes in order to pre-calculate the depth information in a scene based on the scene geometry. These depth passes may process a geometry portion of the depth information. Also, the depth passes may not have any pixel shading associated with the information. In subsequent passes, the depth information that is captured may be used to render the scene, which may allow the workload for pixel shading to be reduced. In some graphics workloads, depth passes may include computations that are primitive heavy and/or quad heavy. For instance, there may not be much pixel computation after the initial depth calculation. The amount of primitives may also account for the size of performance of depth-only geometry. The term “depth” may be referred to as a “z-direction” or “Z-direction” such that “depth-only passes” may be referred to as “z-only passes” or “Z-only passes.”

Additionally, information for depth passes may be stored in a depth buffer or Z-buffer. A depth buffer or Z-buffer may be a type of data buffer used in graphics processing that represents depth information. For instances, a depth buffer or Z-buffer may represent depth information for objects in three-dimensional (3D) space from a particular perspective. The depth information may be stored as a height map of the scene, where the values may represent a distance to camera or viewpoint. A depth buffer may also refer to a texture buffer that stores the depth coordinates or z-coordinates of rendered pixels. The GPU may use this information when drawing new pixels to determine whether to replace or keep the data. This technique may be referred to as “depth testing.”

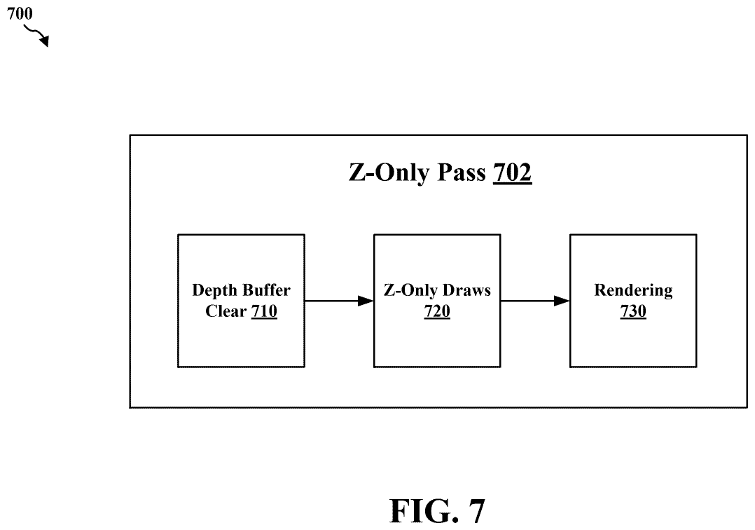

FIG. 7 illustrates diagram 700 including one example of a depth pass operation. More specifically, diagram 700 depicts one example of a depth-only pass or a Z-only pass. As shown in FIG. 7, diagram 700 includes Z-only pass 702 including depth buffer clear 710, Z-only draws 720, and rendering 730. FIG. 7 depicts that the Z-only pass 702 is performed entirely within one graphics pipeline (e.g., a binning render (BR) pipeline). As shown in FIG. 7, a typical data flow for Z-only passes is to start with a depth buffer clear (e.g., depth buffer clear 710), then move to Z-only draws on surfaces (e.g., Z-only draws 720). After this, the depth buffer may be built and used to perform rendering (e.g., rendering 730), such as real color rendering. The rendering 730 may be used as shadow rendering (i.e., creating shadows by testing whether a pixel is visible from a light source) or pre-built depth rendering or Z-rendering.

In some instances, the amount of GPU hardware utilization may be reduced or low for some types of draws or surfaces, such as depth-only passes or Z-only passes. During depth-only or Z-only passes, the GPU may just render to a depth buffer or Z-buffer. That is, during depth-only or Z-only passes, there may not be any other types of buffer rendering (e.g., color buffer rendering). Z-only passes may have a low GPU utilization along with high memory bandwidth demand, such as in binning passes. In some types of applications or games, a decent amount of GPU time may be spent on depth-only or Z-only surfaces, which includes shadow draws or pre-Z draws. However, there may be a reduced amount of pixel shader workloads that correspond to these depth-only surfaces. The GPU utilization of these types of draws may be reduced or low because they have little or no pixel shader workload. Therefore, GPU hardware utilization may be reduced or low when executing certain types of surfaces (e.g., depth-only or Z-only surfaces). Based on the above, it may be beneficial to allow the GPU to elect a workload distribution scheme when the GPU hardware is not fully utilized, such as when executing certain types of surfaces (e.g., depth-only or Z-only surfaces). That is, it may be beneficial for a GPU to move certain workloads (e.g., depth-only or Z-only workloads) to additional hardware pipelines and run concurrently with other workloads.

Aspects of the present disclosure may allow a GPU to elect a workload distribution scheme when the GPU hardware is not fully utilized. For instance, aspects of the present disclosure may allow a GPU to elect a workload distribution scheme when executing certain types of surfaces (e.g., depth-only or Z-only surfaces). That is, aspects presented herein may allow a GPU to move certain workloads to separate and/or additional hardware pipelines. For example, aspects presented herein may allow a GPU to move certain workloads (e.g., depth-only or Z-only workloads) to additional hardware pipelines (e.g., binning render (BR) pipeline and/or a binning visibility (BV) pipeline). In one example, aspects presented herein may move the execution of workloads (e.g., depth-only or Z-only workloads) from solely a BR pipeline to both a BV pipeline and a BR pipeline. After moving the workloads to separate and/or additional hardware pipelines, aspects presented herein may allow the workloads to run concurrently with other workloads. The concurrent execution of workloads (e.g., depth-only or Z-only workloads) may allow a GPU to balance its workloads, so the GPU hardware can be utilized more efficiently. Indeed, aspects presented herein may also a GPU to balance workloads to in order to achieve more concurrency and better utilize the GPU resources. In some aspects, the BV pipeline may work ahead (e.g., on frame N+1) while the BR pipeline is still working on frame N. This way, the BV pipeline (i.e., working on Z-only draws) may run concurrently with the BR pipeline (i.e., working on a different surface) and improve the GPU utilization and efficiency. As such, in some aspects, the BV pipeline and the BR pipeline may not work on the same Z-only surface concurrently.

Aspects presented herein may move depth-only draws to a dedicated GPU pipeline. For example, aspects presented herein may move depth-only draws to a binning render (BR) pipeline and/or a binning visibility (BV) pipeline. That is, aspects presented herein may move Z-only draws (e.g., rendering draws) to the BV pipe, so that they can execute concurrently with normal BR rendering. By doing so, aspects presented herein may allow depth-only draws to execute concurrently with normal GPU rendering (e.g., non-dependent GPU rendering). Hence, aspects presented herein may improve GPU hardware utilization and boost GPU performance. Indeed, by allowing workload overlapping and concurrency at different pipelines (e.g., overlapping and concurrency at the BV pipeline and BR pipeline), aspects presented herein may improve GPU utilization and thus improve overall performance. So aspects presented herein may utilize multiple pipelines to balance workloads. Accordingly, aspects presented herein may assign workloads to be executed in multiple pipelines (e.g., the BR pipeline and the BV pipeline), which may balance the workloads and increase the efficiency of GPU operations. For instance, aspects presented herein may move workloads (e.g., depth-only workloads) to the one pipeline (e.g., a BV pipeline), which will balance the workloads to achieve more concurrency in order to better utilize the GPU resources.

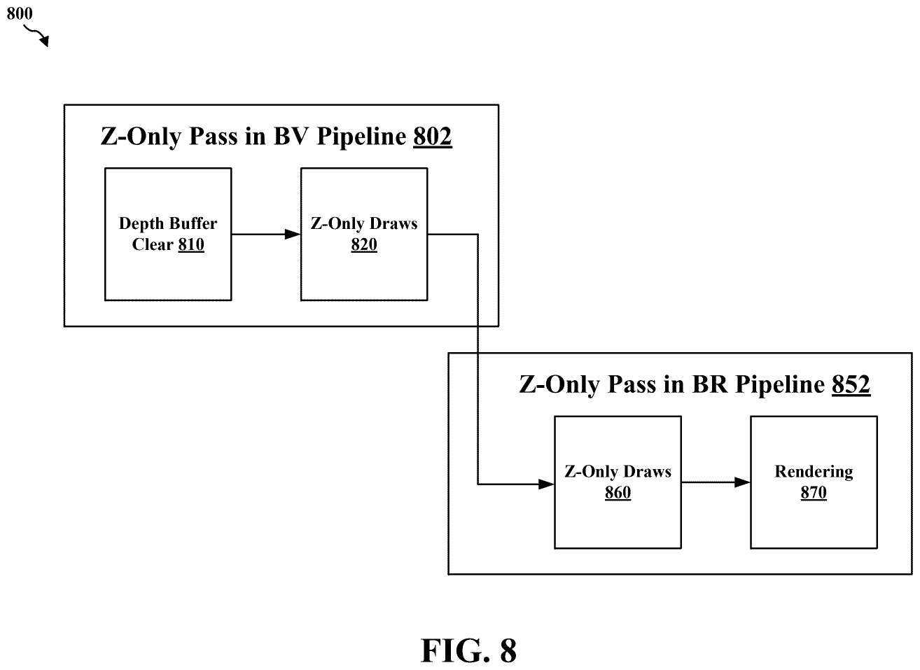

FIG. 8 illustrates diagram 800 including one example of a depth pass operation. More specifically, diagram 800 depicts one example of a depth-only pass or a Z-only pass at multiple pipelines. As shown in FIG. 8, diagram 800 includes Z-only pass in BV pipeline 802 including depth buffer clear 810 and Z-only draws 820. Diagram 800 also includes Z-only pass in BR pipeline 852 including Z-only draws 860 and rendering 870. FIG. 8 depicts that the Z-only pass is performed in both BV pipeline 802 and BR pipeline 852. For instance, the Z-only pass may be performed concurrently within both BV pipeline 802 and BR pipeline 852. As shown in FIG. 8, a novel data flow for Z-only passes according to aspects presented herein may start with a depth buffer clear (e.g., depth buffer clear 810), and then perform Z-only draws on surfaces (e.g., Z-only draws 820) in BV pipeline 802. Concurrently, Z-only draws may be performed on surfaces (e.g., Z-only draws 860) in BR pipeline 852. That is, since the Z-only pass may be running on one pipeline (e.g., BV pipeline 802), the Z-only pass can also run concurrently on another pipeline (e.g., BR pipeline 852). Also, the depth buffer may be built in one pipeline (e.g., BR pipeline 852) and used to perform rendering (e.g., rendering 870), such as real color rendering. The rendering 870 may be used as shadow rendering (i.e., creating shadows by testing whether a pixel is visible from a light source) or pre-built depth rendering or Z-rendering.

Additionally, aspects presented herein may utilize certain types of draws (e.g., fragment shader (FS) draws) in Z-only passes. Aspects presented herein may handle these types of draws (e.g., fragment shader draws), so that the GPU may work efficiently. For instance, the Z-only passes may be split into two parts from one draw (e.g., fragment shader draw), so that one half of draws are disabled (e.g., fragment shader disabled) and can be put in the BV pipe, while the other half of draws (e.g., fragment shader enabled or disabled draws) may be placed in the BR pipe. To overcome this issue, aspects presented herein may utilize another option called drawcall sorting. For example, aspects presented herein may execute certain draws (e.g., fragment shader disabled draws) in the BV pipe, while other draws (e.g., fragment shader enabled draws) may be skipped in the BV pipe and executed in the BR pipe. By doing so, this may change the execution order, but the final z-buffer may still be the same, regardless of the draw-call order. Also, by running all disabled draws (e.g., fragment shader disabled draws) first, aspects presented herein may have an improved z-buffer before running any other types of draws (e.g., fragment shader draws), which may potentially reduce the amount of workload (e.g., fragment shader workload). As indicated herein, aspects presented herein may allow a GPU to distribute z-only draws by fragment shader enable/disable to BV/BR pipes accordingly. For instance, driver set markers may tell a BV command processor (CP) to execute fragment shader disabled draws, and defer fragment shader enabled draws to BR. Also, the BV pipeline may output a per-draw visibility stream which will be read later by a BR pipeline to execute fragment shader enabled draws. Drawcall sorting may change the execution order, but not the final z buffer. Furthermore, the fragment shader workload in the BR pipeline may also be reduced.

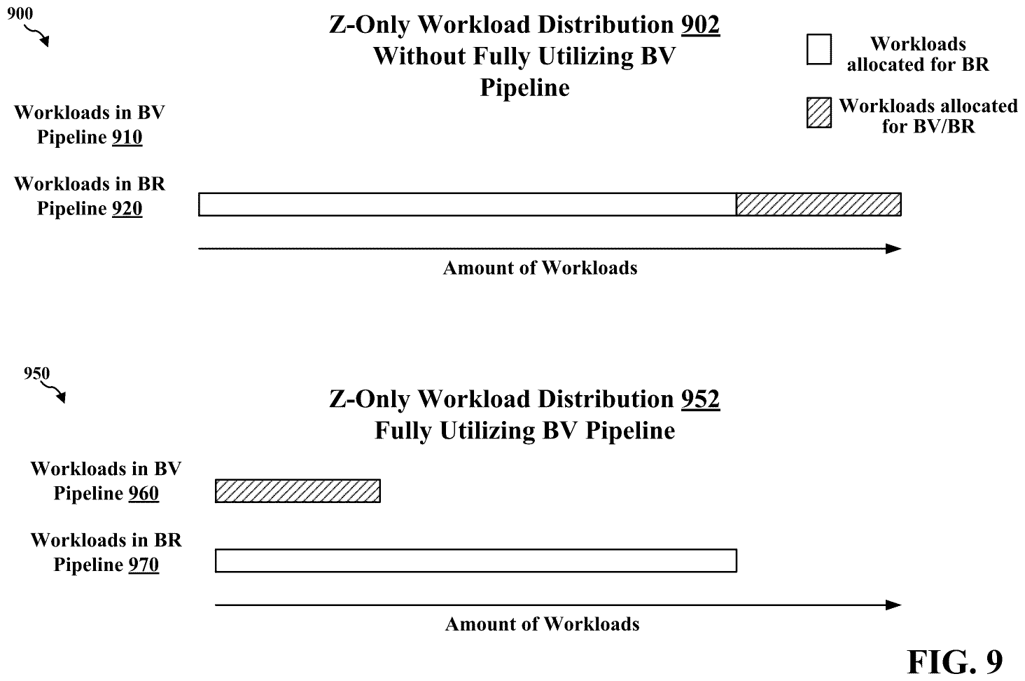

FIG. 9 illustrates diagram 900 including one example of a workload distribution. More specifically, diagram 900 depicts one example of a depth pass workload distribution without utilizing a BV pipeline and an example of a depth pass workload distribution utilizing a BV pipeline. As shown in FIG. 9, diagram 900 includes a Z-only workload distribution 902 without fully utilizing a BV pipeline, which depicts workloads in BV pipeline 910 and workloads in BR pipeline 920. Diagram 900 depicts that workloads allocated for BR pipeline are represented as white, and workloads allocated for BV/BR pipeline are diagonal lines. As shown in FIG. 9, diagram 950 includes a Z-only workload distribution 952 by fully utilizing a BV pipeline, which depicts workloads in BV pipeline 960 and workloads in BR pipeline 970. Diagram 950 depicts that the workloads in BV pipeline 960 can be greatly increased when fully utilizing the BV pipeline. In turn, fully utilizing the BV pipeline will help to balance the workloads between the BV pipeline and the BR pipeline. Balancing the workloads between the BV pipeline and the BR pipeline may increase the efficiency of GPU operations. That is, aspects presented herein may assign workloads to be executed in multiple pipelines (e.g., the BR pipeline and the BV pipeline), which may balance the workloads and increase the efficiency of GPU operations. For instance, aspects presented herein may move workloads (e.g., depth-only workloads) from one pipeline (e.g., BR pipeline 970) to another pipeline (e.g., a BV pipeline 960), which will balance the workloads to achieve more concurrency in order to better utilize the GPU resources. Indeed, balancing the workloads (as in diagram 950) will allow GPUs to more efficiently utilize GPU resources.

Further, aspects presented herein may utilize load balancing or workload balancing. For instance, aspects presented herein may allow a GPU to balance workloads between different pipelines (e.g., balance workloads between a BV pipeline and a BR pipeline). In some instances, a binning pass may be executed in a BV pipeline. Also, z-only draws may be moved to the BV pipe. Given an increased workload and lower priority (e.g., lower than BR pipeline), sometimes the BV pipeline may stick out and leaving the BR pipeline idle waiting for BV. This issue (i.e., BR pipe waiting for BV pipe) may occur more often when a vertical synchronization (VSYNC) is ON, such as when there is one frame in the GPU pipeline with BV-BR intra-frame dependency. In some aspects, before each BV draw, a driver may insert marker for CP micro-code to detect whether the BR pipe is waiting for the BV pipe. If true, aspects herein may punt all following BV draws of this surface to BR pipe, leveraging an overflow mechanism. Similarly, aspects presented herein may utilize a driver insert marker for CP to punt all following BV draws to the BR pipe.

In some aspects, to support a BV/BR drawcall distribution and work balance, aspects presented herein may utilize a per-draw-visibility stream or buffer, which may be referred to as a draw skip stream. During a depth-only pass in the BV pipe, a CP BV thread may examine draws. The driver may add a marker to say whether each draw should be executed by the BV pipe (usually FS-disabled draws) or by the BR pipe. The driver may also add a new event at the start of the depth pass. All draws that the BV pipe sends to may result in the generation of an invisible draw token. All draws that the BV pipe skips may result in the BV pipe sending a new always-visible event, which results in a generation of a visible draw token. Invisible tokens may be merged. Also, the BR pipe in the CP may use the new visibility stream to fetch the depth-pass draws that were deferred by the BV pipe. The BV pipe may also send a new all draws visible event, resulting in the equivalent of legacy token. This may occur if the BV pipe decides to postpone all remaining draws to the BR pipe, due to load balancing.

Additionally, aspects herein may utilize a BV depth clear, where a depth buffer may be cleared from the BV pipe for enabled z-only surfaces. For instance, in the BV pipe, a “compact and sequential” resolve engine may be added to support fast clear, partial clear and unaligned depth buffer clear, etc. In the BR pipe, a driver may skip the depth buffer clear.

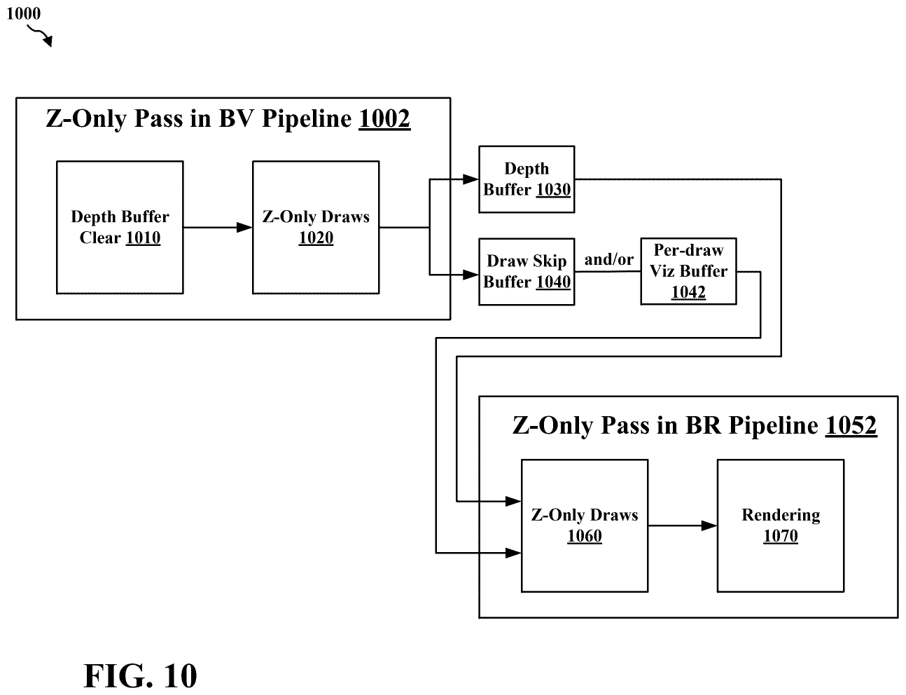

FIG. 10 illustrates diagram 1000 including one example of a depth pass operation. More specifically, diagram 1000 depicts one example of a depth-only pass or a Z-only pass at multiple pipelines. As shown in FIG. 10, diagram 1000 includes Z-only pass in BV pipeline 1002 including depth buffer clear 1010 and Z-only draws 1020. After the Z-only pass in BV pipeline 1002, diagram 1000 includes a depth buffer 1030, as well as a draw skip buffer 1040 and/or a per-draw visibility buffer 1042. The draw skip buffer 1040 depicts an embodiment utilizing the aforementioned draw skip stream. Also, the per-draw visibility buffer 1042 depicts an embodiment utilizing the aforementioned BV depth clear. Diagram 1000 also includes Z-only pass in BR pipeline 1052 including Z-only draws 1060 and rendering 1070. FIG. 10 depicts that the Z-only pass is performed in both BV pipeline 1002 and BR pipeline 1052. For instance, the Z-only pass may be performed concurrently within both BV pipeline 1002 and BR pipeline 1052. As shown in FIG. 10, a data flow for Z-only passes according to aspects presented herein may start with a depth buffer clear (e.g., depth buffer clear 1010), and then perform Z-only draws on surfaces (e.g., Z-only draws 1020) in BV pipeline 1002. Concurrently, Z-only draws may be performed on surfaces (e.g., Z-only draws 1060) in BR pipeline 1052. That is, since the Z-only pass may be running on one pipeline (e.g., BV pipeline 1002), the Z-only pass can also run concurrently on another pipeline (e.g., BR pipeline 1052). Also, the depth buffer may be built (e.g., depth buffer 1030) and used to perform rendering (e.g., rendering 1070), such as real color rendering. The rendering 1070 may be used as shadow rendering (i.e., creating shadows by testing whether a pixel is visible from a light source) or pre-built depth rendering or Z-rendering. Also, the draw skip buffer 1040 may be utilized to perform a draw skip.

In some aspects, a BV pipe may try to execute z-only surface ahead. The most common usage is to run into next frame while the BV pipe may still work on this frame. One issue is that depth buffer is often reused cross frames. Stalling may leave bubbles in the BV pipe, which lowers the BV/BR overlapping opportunities. It also blocks the binning pass of next surfaces from execution in BV pipe. To overcome these issues, aspects presented herein may utilize a double depth buffer. Basically, BV can use the pong depth buffer while ping buffer is still in use by BR, or vice versa. As shown below, with double depth buffer, aspects presented herein may remove the bubbles in BV pipe, left shift the z-only and binning passes of next frame and run concurrently with BR (of current frame). For most benchmarks, double depth buffer can eliminate the performance degradation, but also boost quite some performance. Aspects presented herein may eliminate the software complexities to track the depth resource dependencies. Instead, the hardware may simply track the resource usage with a tracking table and counters in the CP. Aspects herein may utilize the double depth buffer for z-only surfaces. Also, aspects herein may set a cap for the size of extra depth buffers.

Additionally, aspects herein may utilize meta data buffers for driver and hardware to manage ping-pong buffers. Meta buffer includes a number of entries (e.g., 16 entries) of the surfaces' information of double depth buffer, as well as valid mask for each entry. Each entry may store information of one z-only surface, includes ping-pong pointer, surface size, as well as base address of both ping and pong buffer. A driver may add, update, or destroy some entries on boundaries. There may also be an entry valid mask to indicate which entries are valid. And the ‘ping-pong’ pointer may always be initialized to 0 (point to ping). There may be 16 entries which may be enough for multiple z-only surfaces coexist in GPU. Not that, for a depth array, each entry holds one slice of buffer, instead of the whole array, this is because slices may run into different pointers. If the table entries are used up, driver may disable this process for following z-only surfaces until some entries are released. Since BV and BR pipe run asynchronously (run into different frame/surfaces), hence there may be one 16-entry mapping table for each BV/BR pipe so that they can be updated/destroyed individually.

In some aspects, a mapping table may be fetched by the CP and programmed to hardware as non-context registers. The hardware may look up the table to see whether a system memory request is heading to “double depth buffer” by comparing against the ping address ranges. If it is within the address range, the hardware may check the pointer and may remap the address to pong space. Also, to avoid such checking for every memory request (to save power), aspects herein may use the “IsDepthBufferReq” hint from upstream clients. Another specification from GPU hardware is that the address be known before and after remapping locate in the same channel.

In some aspects, similar to a ping-pong buffer, a new event “DepthBufferFlip” may be added to manage a double depth buffer. This event may be triggered by depth buffer clear command. There may also be a table to add the resource into the resource table. The CP will track its usage with a counter associated similar to the LRZ ones. For each BV/BR pipe, upon receiving DepthBufferFlip event, the hardware may also flip the pointer of the matching mapping table entry. To simplify hardware, the CP may block the next draws from kick into this pipe until DepthBufferFlip event is compete in the GPU. This is to ensure each pipe (BV/BR) may work on one buffer—either ping or pong, but not both. Note that BV and BR can work on ping and pong buffers simultaneously, as this is the intention of double buffer.

In some aspects, when z-only surfaces are moved to the BV pipe, aspects herein may leverage existing hardware which is already shared between BV/BR pipes. For instance, aspects herein may utilize render backend (RB) or cache and compression unit (CCU) cache depth logic in the BV pipe as well. One option is use dedicated hardware for this purpose. If aspects herein reduce its throughput or cache size, then the BV pipe may be exposed as a bottleneck. A better option may be to include a separate pattern for logic sharing for all units throughout the GPU pipeline. In fact, there is some depth logic sharing between early Z-pass and late Z-pass in conservative Z mode. Based on this, aspects herein may easily support logic sharing for all units throughout the GPU pipeline (e.g., by adding one extra early-z BV client).

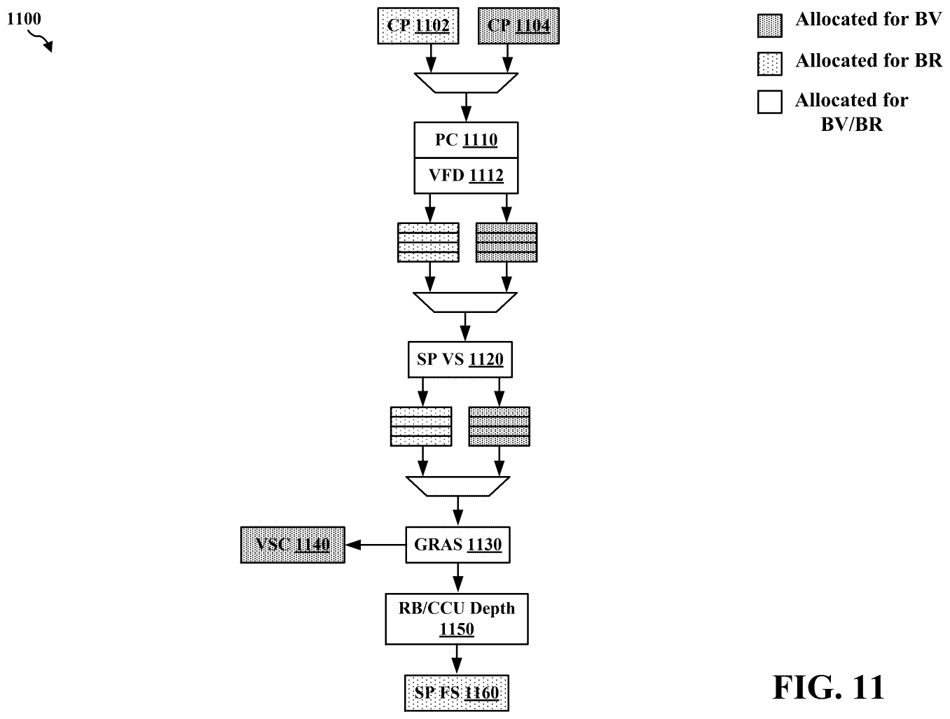

FIG. 11 illustrates diagram 1100 including one example of a GPU. More specifically, diagram 1100 depicts one example of hardware logic sharing in a GPU. As shown in FIG. 11, diagram 1100 includes CP 1102, CP 1104, primitive controller (PC) 1110, VFD 1112, SP VS 1120, graphics rasterizer (GRAS) 1130, visibility stream compressor (VSC) 1140, RB/CCU depth component 1150, and SP FS 1160. FIG. 11 depicts a GPU that shares the RB/CCU logic by utilizing RB/CCU depth component 1150. Also, FIG. 11 shows that certain components may be allocated for the BV pipe, certain components may be allocated for the BR pipe, and certain components may be allocated to both the BV and BR pipes. FIG. 11 depicts that when z-only surfaces are moved to the BV pipe, aspects herein may leverage existing hardware which is already shared between BV/BR pipes. For instance, aspects herein may utilize RB or CCU cache depth logic in the BV pipe. As shown in FIG. 11, aspects presented herein may utilize dedicated hardware for this purpose, such as RB/CCU depth component 1150. That is, aspects presented herein may share logic between the RB and CCU cache (e.g., with RB/CCU depth component 1150) to support when z-only surfaces are moved to the BV pipe.

Aspects presented herein may also utilize a depth cache. For instance, the shadow pass in the BV pipe may use a portion of the existing CCU depth cache. The BV cache and BR cache share the total CCU depth cache which has a number of cache blocks (e.g., 256 cache blocks with 1 KB per block) in each CCU. But logically they may be separated, and physically they can be in different space in GMEM (programmed with a different base address). The driver is responsible to ensure that they do not overlap. Additionally, most of z-only draws are in the BV pipe, so there is little benefit of binning. Therefore, direct render mode may be utilized for z-only surfaces.

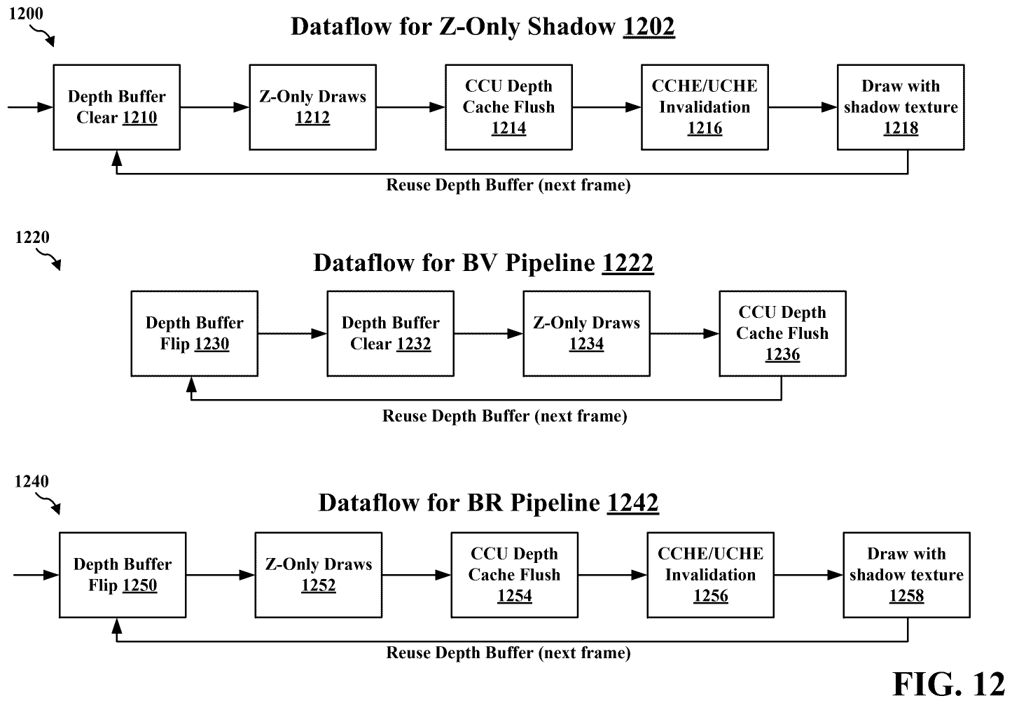

FIG. 12 illustrates diagram 1200 including one example of a dataflow for depth pass operations. More specifically, diagram 1200 depicts one example dataflow for a Z-only shadow 1202. As shown in FIG. 12, diagram 1200 includes dataflow for Z-only shadow 1202 including depth buffer clear 1210, Z-only draws 1212, CCU depth cache flush 1214, CCHE/UCHE invalidation 1216, draw with shadow texture 1218, and reuse depth buffer (for the next frame). FIG. 12 also depicts diagram 1220 including dataflow for BV pipeline 1222 including depth buffer flip 1230, depth buffer clear 1232, Z-only draws 1234, CCU depth cache flush 1236, and reuse depth buffer (for the next frame). FIG. 12 also depicts diagram 1240 including dataflow for BR pipeline 1242 including depth buffer flip 1250, Z-only draws 1252, CCU depth cache flush 1254, CCHE/UCHE invalidation 1256, draw with shadow texture 1258, and reuse depth buffer (for the next frame).

Aspects of the present disclosure may include a number of benefits or advantages. For instance, aspects of the present disclosure may allow a GPU to elect a workload distribution scheme when the GPU hardware is not fully utilized. Aspects of the present disclosure may allow a GPU to elect a workload distribution scheme when executing certain types of surfaces (e.g., depth-only or Z-only surfaces). That is, aspects presented herein may allow a GPU to move certain workloads to separate and/or additional hardware pipelines. For example, aspects presented herein may allow a GPU to move certain workloads (e.g., depth-only or Z-only workloads) to additional hardware pipelines (e.g., binning render (BR) pipeline and/or a binning visibility (BV) pipeline). In one example, aspects presented herein may move the execution of workloads (e.g., depth-only or Z-only workloads) from solely a BR pipeline to both a BV pipeline and a BR pipeline. After moving the workloads to separate and/or additional hardware pipelines, aspects presented herein may allow the workloads to run concurrently with other workloads. The concurrent execution of workloads (e.g., depth-only or Z-only workloads) may allow a GPU to balance its workloads, so the GPU hardware can be utilized more efficiently. Indeed, aspects presented herein may also a GPU to balance workloads to in order to achieve more concurrency and better utilize the GPU resources.

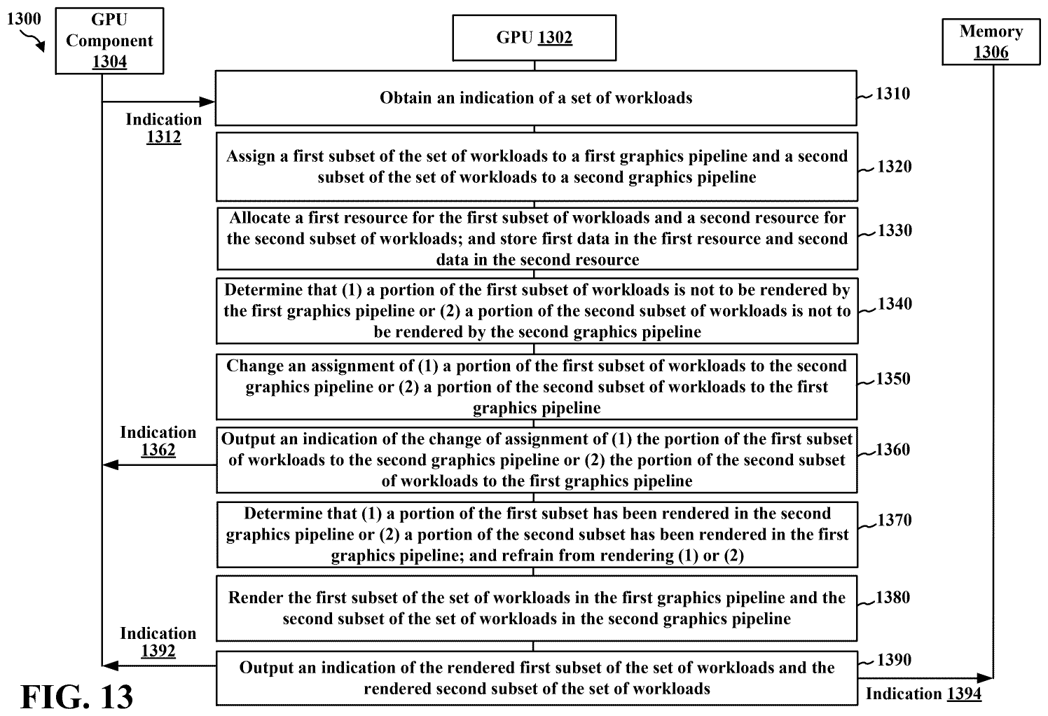

FIG. 13 is a communication flow diagram 1300 of graphics processing in accordance with one or more techniques of this disclosure. As shown in FIG. 13, diagram 1300 includes example communications between GPU 1302 (e.g., a GPU, a shader processor at a GPU, a GPU component, another graphics processor, a CPU, a CPU component, or another central processor), GPU component 1304 (e.g., a GPU, a shader processor at a GPU, a GPU component, another graphics processor, a CPU, a CPU component, or another central processor), and memory 1306 (e.g., a memory, a cache, a system memory, a graphics memory, a memory or cache at a CPU, or a memory or cache at a GPU), in accordance with one or more techniques of this disclosure.

At 1310, GPU 1302 may obtain an indication of a set of workloads (e.g., GPU 1302 may obtain indication 1312 from GPU component 1304). The set of workloads may be a set of depth-only workloads.

At 1320, GPU 1302 may assign a first subset of the set of workloads to a first graphics pipeline and a second subset of the set of workloads to a second graphics pipeline. In some aspects, the first graphics pipeline may be a binning render (BR) pipeline and the second graphics pipeline may be a binning visibility (BV) pipeline. Also, the first graphics pipeline may be the BV pipeline and the second graphics pipeline may be the BR pipeline. In some aspects, a first portion of the first graphics pipeline and a second portion of the second graphics pipeline may overlap at a shared graphics pipeline. The shared graphics pipeline may be a pixel pipeline, and the set of workloads may be a set of depth-only workloads. In some aspects, the set of workloads may comprise a set of depth pass workloads, and the assignment may be based on a change in a depth direction for the set of depth pass workloads. Also, the assignment may be based on at least one of: the set of workloads being associated with an occlusion query, a stencil being enabled, a depth test direction change, a memory space size limit, a set of mapping table entries, a depth buffer load, a single primitive mode, or a bin rendering mode. In some aspects, assigning the first subset of the set of workloads to the first graphics pipeline and the second subset of the set of workloads to the second graphics pipeline may comprise: mapping the first subset of the set of workloads to the first graphics pipeline and the second subset of the set of workloads to the second graphics pipeline.

At 1330, GPU 1302 may allocate a first resource for the first subset of the set of workloads and a second resource for the second subset of the set of workloads; and store first data associated with the first subset of the set of workloads in the first resource and second data associated with the second subset of the set of workloads in the second resource. The first data may be distinct from the second data, and the allocation of the first resource and the second resource may be based on the first data being distinct from the second data. In some aspects, storing the first data associated with the first subset of the set of workloads in the first resource and the second data associated with the second subset of the set of workloads in the second resource may comprise: concurrently storing the first data associated with the first subset of the set of workloads in the first resource and the second data associated with the second subset of the set of workloads in the second resource. Also, the first resource may be a first depth buffer and the second resource may be a second depth buffer. Further, the first depth buffer and the second depth buffer may be cleared prior to the storage of the first data associated with the first subset of the set of workloads in the first depth buffer and the second data associated with the second subset of the set of workloads in the second depth buffer.

At 1340, GPU 1302 may determine that at least one of (1) a portion of the first subset of the set of workloads is not to be rendered by the first graphics pipeline or (2) a portion of the second subset of the set of workloads is not to be rendered by the second graphics pipeline, where a change of assignment is based on the determination. The determination may be based on at least one of the first graphics pipeline being idle or the second graphics pipeline being idle.

At 1350, GPU 1302 may change an assignment of at least one of (1) a portion of the first subset of the set of workloads to the second graphics pipeline or (2) a portion of the second subset of the set of workloads to the first graphics pipeline.

At 1360, GPU 1302 may output an indication of the change of assignment of at least one of (1) the portion of the first subset of the set of workloads to the second graphics pipeline or (2) the portion of the second subset of the set of workloads to the first graphics pipeline (e.g., GPU 1302 may output indication 1362 to GPU component 1304). In some aspects, outputting the indication of the change of assignment may comprise: outputting the indication of the change of assignment via a visibility stream in a graphics pipeline.

At 1370, GPU 1302 may determine that at least one of (1) a portion of the first subset of the set of workloads has already been rendered in the second graphics pipeline or (2) a portion of the second subset of the set of workloads has already been rendered in the first graphics pipeline; and refrain from rendering at least one of (1) the portion of the first subset of the set of workloads or (2) the portion of the second subset of the workloads in the second graphics pipeline based on the determination.

At 1380, GPU 1302 may render the first subset of the set of workloads in the first graphics pipeline and the second subset of the set of workloads in the second graphics pipeline.

At 1390, GPU 1302 may output an indication of the rendered first subset of the set of workloads and the rendered second subset of the set of workloads. In some aspects, outputting the indication of the rendered first subset of the set of workloads and the rendered second subset of the set of workloads may comprise: transmitting the indication of the rendered first subset of the set of workloads and the rendered second subset of the set of workloads (e.g., GPU 1302 may transmit indication 1392 to GPU component 1304). Also, outputting the indication of the rendered first subset of the set of workloads and the rendered second subset of the set of workloads may comprise storing the indication of the rendered first subset of the set of workloads and the rendered second subset of the set of workloads (e.g., GPU 1302 may store indication 1394 in memory 1306).

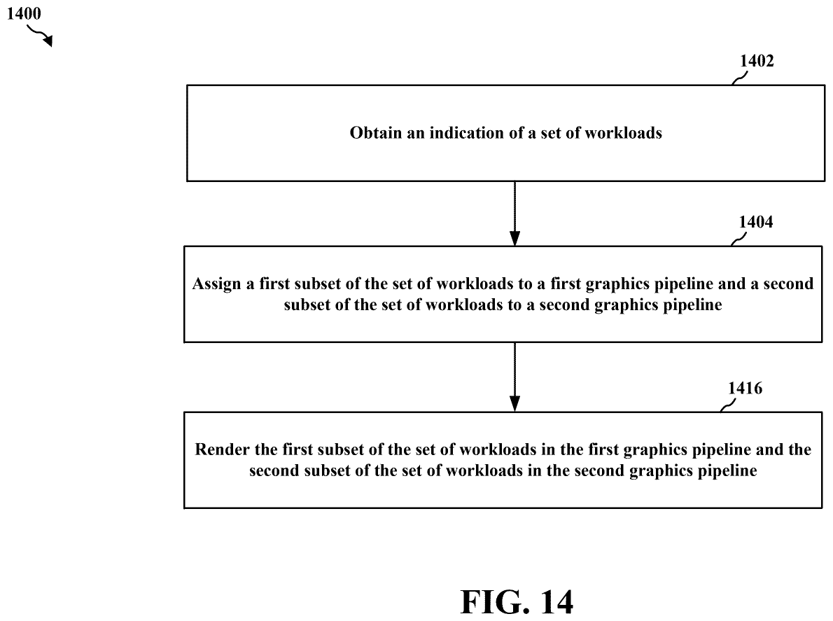

FIG. 14 is a flowchart 1400 of an example method of graphics processing in accordance with one or more techniques of this disclosure. The method may be performed by a GPU (e.g., a GPU, a shader processor at a GPU, a GPU component, another graphics processor, a CPU, a CPU component, or another central processor), a CPU (e.g., a CPU, a CPU component, another central processor, a GPU, a shader processor at a GPU, a GPU component, or another graphics processor), a display driver integrated circuit (DDIC), an apparatus for graphics processing, a wireless communication device, and/or any apparatus that may perform graphics processing as used in connection with the examples of FIGS. 1-13.

At 1402, the GPU may obtain an indication of a set of workloads, as described in connection with the examples in FIGS. 1-13. For example, as described in 1310 of FIG. 13, GPU 1302 may obtain an indication of a set of workloads. Further, step 1402 may be performed by processing unit 120 in FIG. 1. The set of workloads may be a set of depth-only workloads.

At 1404, the GPU may assign a first subset of the set of workloads to a first graphics pipeline and a second subset of the set of workloads to a second graphics pipeline, as described in connection with the examples in FIGS. 1-13. For example, as described in 1320 of FIG. 13, GPU 1302 may assign a first subset of the set of workloads to a first graphics pipeline and a second subset of the set of workloads to a second graphics pipeline. Further, step 1404 may be performed by processing unit 120 in FIG. 1. In some aspects, the first graphics pipeline may be a binning render (BR) pipeline and the second graphics pipeline may be a binning visibility (BV) pipeline. Also, the first graphics pipeline may be the BV pipeline and the second graphics pipeline may be the BR pipeline. In some aspects, a first portion of the first graphics pipeline and a second portion of the second graphics pipeline may overlap at a shared graphics pipeline. The shared graphics pipeline may be a pixel pipeline, and the set of workloads may be a set of depth-only workloads. In some aspects, the set of workloads may comprise a set of depth pass workloads, and the assignment may be based on a change in a depth direction for the set of depth pass workloads. Also, the assignment may be based on at least one of: the set of workloads being associated with an occlusion query, a stencil being enabled, a depth test direction change, a memory space size limit, a set of mapping table entries, a depth buffer load, a single primitive mode, or a bin rendering mode. In some aspects, assigning the first subset of the set of workloads to the first graphics pipeline and the second subset of the set of workloads to the second graphics pipeline may comprise: mapping the first subset of the set of workloads to the first graphics pipeline and the second subset of the set of workloads to the second graphics pipeline.

At 1416, the GPU may render the first subset of the set of workloads in the first graphics pipeline and the second subset of the set of workloads in the second graphics pipeline, as described in connection with the examples in FIGS. 1-13. For example, as described in 1380 of FIG. 13, GPU 1302 may render the first subset of the set of workloads in the first graphics pipeline and the second subset of the set of workloads in the second graphics pipeline. Further, step 1416 may be performed by processing unit 120 in FIG. 1.

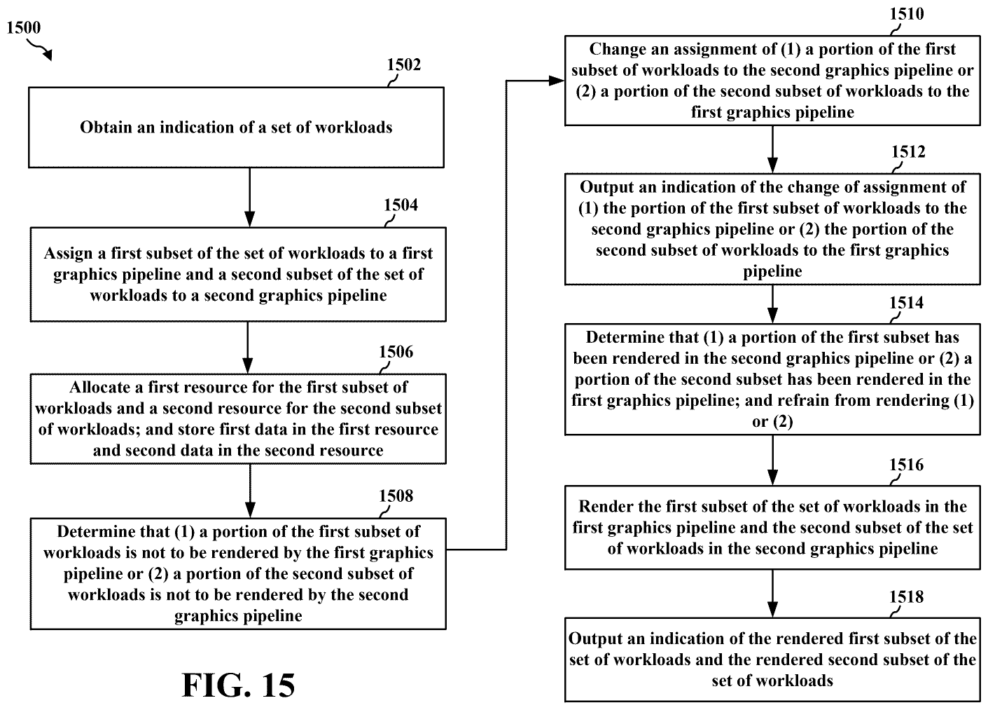

FIG. 15 is a flowchart 1500 of an example method of graphics processing in accordance with one or more techniques of this disclosure. The method may be performed by a GPU (e.g., a GPU, a shader processor at a GPU, a GPU component, another graphics processor, a CPU, a CPU component, or another central processor), a CPU (e.g., a CPU, a CPU component, another central processor, a GPU, a shader processor at a GPU, a GPU component, or another graphics processor), a display driver integrated circuit (DDIC), an apparatus for graphics processing, a wireless communication device, and/or any apparatus that may perform graphics processing as used in connection with the examples of FIGS. 1-13.

At 1502, the GPU may obtain an indication of a set of workloads, as described in connection with the examples in FIGS. 1-13. For example, as described in 1310 of FIG. 13, GPU 1302 may obtain an indication of a set of workloads. Further, step 1502 may be performed by processing unit 120 in FIG. 1. The set of workloads may be a set of depth-only workloads.

At 1504, the GPU may assign a first subset of the set of workloads to a first graphics pipeline and a second subset of the set of workloads to a second graphics pipeline, as described in connection with the examples in FIGS. 1-13. For example, as described in 1320 of FIG. 13, GPU 1302 may assign a first subset of the set of workloads to a first graphics pipeline and a second subset of the set of workloads to a second graphics pipeline. Further, step 1504 may be performed by processing unit 120 in FIG. 1. In some aspects, the first graphics pipeline may be a binning render (BR) pipeline and the second graphics pipeline may be a binning visibility (BV) pipeline. Also, the first graphics pipeline may be the BV pipeline and the second graphics pipeline may be the BR pipeline. In some aspects, a first portion of the first graphics pipeline and a second portion of the second graphics pipeline may overlap at a shared graphics pipeline. The shared graphics pipeline may be a pixel pipeline, and the set of workloads may be a set of depth-only workloads. In some aspects, the set of workloads may comprise a set of depth pass workloads, and the assignment may be based on a change in a depth direction for the set of depth pass workloads. Also, the assignment may be based on at least one of: the set of workloads being associated with an occlusion query, a stencil being enabled, a depth test direction change, a memory space size limit, a set of mapping table entries, a depth buffer load, a single primitive mode, or a bin rendering mode. In some aspects, assigning the first subset of the set of workloads to the first graphics pipeline and the second subset of the set of workloads to the second graphics pipeline may comprise: mapping the first subset of the set of workloads to the first graphics pipeline and the second subset of the set of workloads to the second graphics pipeline.

At 1506, the GPU may allocate a first resource for the first subset of the set of workloads and a second resource for the second subset of the set of workloads; and store first data associated with the first subset of the set of workloads in the first resource and second data associated with the second subset of the set of workloads in the second resource, as described in connection with the examples in FIGS. 1-13. For example, as described in 1330 of FIG. 13, GPU 1302 may allocate a first resource for the first subset of the set of workloads and a second resource for the second subset of the set of workloads; and store first data associated with the first subset of the set of workloads in the first resource and second data associated with the second subset of the set of workloads in the second resource. Further, step 1506 may be performed by processing unit 120 in FIG. 1. The first data may be distinct from the second data, and the allocation of the first resource and the second resource may be based on the first data being distinct from the second data. In some aspects, storing the first data associated with the first subset of the set of workloads in the first resource and the second data associated with the second subset of the set of workloads in the second resource may comprise: concurrently storing the first data associated with the first subset of the set of workloads in the first resource and the second data associated with the second subset of the set of workloads in the second resource. Also, the first resource may be a first depth buffer and the second resource may be a second depth buffer. Further, the first depth buffer and the second depth buffer may be cleared prior to the storage of the first data associated with the first subset of the set of workloads in the first depth buffer and the second data associated with the second subset of the set of workloads in the second depth buffer.

At 1508, the GPU may determine that at least one of (1) a portion of the first subset of the set of workloads is not to be rendered by the first graphics pipeline or (2) a portion of the second subset of the set of workloads is not to be rendered by the second graphics pipeline, where a change of assignment is based on the determination, as described in connection with the examples in FIGS. 1-13. For example, as described in 1340 of FIG. 13, GPU 1302 may determine that at least one of (1) a portion of the first subset of the set of workloads is not to be rendered by the first graphics pipeline or (2) a portion of the second subset of the set of workloads is not to be rendered by the second graphics pipeline, where a change of assignment is based on the determination. Further, step 1508 may be performed by processing unit 120 in FIG. 1. The determination may be based on at least one of the first graphics pipeline being idle or the second graphics pipeline being idle.

At 1510, the GPU may change an assignment of at least one of (1) a portion of the first subset of the set of workloads to the second graphics pipeline or (2) a portion of the second subset of the set of workloads to the first graphics pipeline, as described in connection with the examples in FIGS. 1-13. For example, as described in 1350 of FIG. 13, GPU 1302 may change an assignment of at least one of (1) a portion of the first subset of the set of workloads to the second graphics pipeline or (2) a portion of the second subset of the set of workloads to the first graphics pipeline. Further, step 1510 may be performed by processing unit 120 in FIG. 1.

At 1512, the GPU may output an indication of the change of assignment of at least one of (1) the portion of the first subset of the set of workloads to the second graphics pipeline or (2) the portion of the second subset of the set of workloads to the first graphics pipeline, as described in connection with the examples in FIGS. 1-13. For example, as described in 1360 of FIG. 13, GPU 1302 may output an indication of the change of assignment of at least one of (1) the portion of the first subset of the set of workloads to the second graphics pipeline or (2) the portion of the second subset of the set of workloads to the first graphics pipeline. Further, step 1512 may be performed by processing unit 120 in FIG. 1. In some aspects, outputting the indication of the change of assignment may comprise: outputting the indication of the change of assignment via a visibility stream in a graphics pipeline.

At 1514, the GPU may determine that at least one of (1) a portion of the first subset of the set of workloads has already been rendered in the second graphics pipeline or (2) a portion of the second subset of the set of workloads has already been rendered in the first graphics pipeline; and refrain from rendering at least one of (1) the portion of the first subset of the set of workloads or (2) the portion of the second subset of the workloads in the second graphics pipeline based on the determination, as described in connection with the examples in FIGS. 1-13. For example, as described in 1370 of FIG. 13, GPU 1302 may determine that at least one of (1) a portion of the first subset of the set of workloads has already been rendered in the second graphics pipeline or (2) a portion of the second subset of the set of workloads has already been rendered in the first graphics pipeline; and refrain from rendering at least one of (1) the portion of the first subset of the set of workloads or (2) the portion of the second subset of the workloads in the second graphics pipeline based on the determination. Further, step 1514 may be performed by processing unit 120 in FIG. 1.

At 1516, the GPU may render the first subset of the set of workloads in the first graphics pipeline and the second subset of the set of workloads in the second graphics pipeline, as described in connection with the examples in FIGS. 1-13. For example, as described in 1380 of FIG. 13, GPU 1302 may render the first subset of the set of workloads in the first graphics pipeline and the second subset of the set of workloads in the second graphics pipeline. Further, step 1516 may be performed by processing unit 120 in FIG. 1.

At 1518, the GPU may output an indication of the rendered first subset of the set of workloads and the rendered second subset of the set of workloads, as described in connection with the examples in FIGS. 1-13. For example, as described in 1390 of FIG. 13, GPU 1302 may output an indication of the rendered first subset of the set of workloads and the rendered second subset of the set of workloads. Further, step 1518 may be performed by processing unit 120 in FIG. 1. In some aspects, outputting the indication of the rendered first subset of the set of workloads and the rendered second subset of the set of workloads may comprise: transmitting the indication of the rendered first subset of the set of workloads and the rendered second subset of the set of workloads. Also, outputting the indication of the rendered first subset of the set of workloads and the rendered second subset of the set of workloads may comprise storing the indication of the rendered first subset of the set of workloads and the rendered second subset of the set of workloads.

In configurations, a method or an apparatus for graphics processing is provided. The apparatus may be a GPU (or other graphics processor), a CPU (or other central processor), a DDIC, an apparatus for graphics processing, and/or some other processor that may perform graphics processing. In aspects, the apparatus may be the processing unit 120 within the device 104, or may be some other hardware within the device 104 or another device. The apparatus, e.g., processing unit 120, may include means for obtaining an indication of a set of workloads. The apparatus, e.g., processing unit 120, may also include means for assigning a first subset of the set of workloads to a first graphics pipeline and a second subset of the set of workloads to a second graphics pipeline. The apparatus, e.g., processing unit 120, may also include means for rendering the first subset of the set of workloads in the first graphics pipeline and the second subset of the set of workloads in the second graphics pipeline. The apparatus, e.g., processing unit 120, may also include means for changing an assignment of at least one of (1) a portion of the first subset of the set of workloads to the second graphics pipeline or (2) a portion of the second subset of the set of workloads to the first graphics pipeline. The apparatus, e.g., processing unit 120, may also include means for determining that at least one of (1) the portion of the first subset of the set of workloads is not to be rendered by the first graphics pipeline or (2) the portion of the second subset of the set of workloads is not to be rendered by the second graphics pipeline, where the change of assignment is based on the determination. The apparatus, e.g., processing unit 120, may also include means for outputting an indication of the change of assignment of at least one of (1) the portion of the first subset of the set of workloads to the second graphics pipeline or (2) the portion of the second subset of the set of workloads to the first graphics pipeline. The apparatus, e.g., processing unit 120, may also include means for allocating a first resource for the first subset of the set of workloads and a second resource for the second subset of the set of workloads; and means for storing first data associated with the first subset of the set of workloads in the first resource and second data associated with the second subset of the set of workloads in the second resource. The apparatus, e.g., processing unit 120, may also include means for determining that at least one of (1) a portion of the first subset of the set of workloads has already been rendered in the second graphics pipeline or (2) a portion of the second subset of the set of workloads has already been rendered in the first graphics pipeline; and means for refraining from rendering at least one of (1) the portion of the first subset of the set of workloads or (2) the portion of the second subset of the workloads in the second graphics pipeline based on the determination. The apparatus, e.g., processing unit 120, may also include means for outputting an indication of the rendered first subset of the set of workloads and the rendered second subset of the set of workloads.

The subject matter described herein may be implemented to realize one or more benefits or advantages. For instance, the described graphics processing techniques may be used by a GPU, a shader processor, a CPU, a central processor, or some other processor that may perform graphics processing to implement the concurrent execution techniques described herein. This may also be accomplished at a low cost compared to other graphics processing techniques. Moreover, the graphics processing techniques herein may improve or speed up data processing or execution. Further, the graphics processing techniques herein may improve resource or data utilization and/or resource efficiency. Additionally, aspects of the present disclosure may utilize concurrent execution techniques in order to improve memory bandwidth efficiency and/or increase processing speed at a GPU, a shader processor, a CPU, or a DPU.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language of the claims, wherein reference to an element in the singular is not intended to mean “one and only one” unless specifically so stated, but rather “one or more.” The word “exemplary” is used herein to mean “serving as an example, instance, or illustration.” Any aspect described herein as “exemplary” is not necessarily to be construed as preferred or advantageous over other aspects.

Unless specifically stated otherwise, the term “some” refers to one or more and the term “or” may be interpreted as “and/or” where context does not dictate otherwise. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

In one or more examples, the functions described herein may be implemented in hardware, software, firmware, or any combination thereof. For example, although the term “processing unit” has been used throughout this disclosure, such processing units may be implemented in hardware, software, firmware, or any combination thereof. If any function, processing unit, technique described herein, or other module is implemented in software, the function, processing unit, technique described herein, or other module may be stored on or transmitted over as one or more instructions or code on a computer-readable medium.

In accordance with this disclosure, the term “or” may be interpreted as “and/or” where context does not dictate otherwise. Additionally, while phrases such as “one or more” or “at least one” or the like may have been used for some features disclosed herein but not others, the features for which such language was not used may be interpreted to have such a meaning implied where context does not dictate otherwise.

In one or more examples, the functions described herein may be implemented in hardware, software, firmware, or any combination thereof. For example, although the term “processing unit” has been used throughout this disclosure, such processing units may be implemented in hardware, software, firmware, or any combination thereof. If any function, processing unit, technique described herein, or other module is implemented in software, the function, processing unit, technique described herein, or other module may be stored on or transmitted over as one or more instructions or code on a computer-readable medium. Computer-readable media may include computer data storage media or communication media including any medium that facilitates transfer of a computer program from one place to another. In this manner, computer-readable media generally may correspond to (1) tangible computer-readable storage media, which is non-transitory or (2) a communication medium such as a signal or carrier wave. Data storage media may be any available media that may be accessed by one or more computers or one or more processors to retrieve instructions, code and/or data structures for implementation of the techniques described in this disclosure. By way of example, and not limitation, such computer-readable media may comprise RAM, ROM, EEPROM, CD-ROM or other optical disk storage, magnetic disk storage or other magnetic storage devices. Disk and disc, as used herein, includes compact disc (CD), laser disc, optical disc, digital versatile disc (DVD), floppy disk and Blu-ray disc where disks usually reproduce data magnetically, while discs reproduce data optically with lasers. Combinations of the above should also be included within the scope of computer-readable media. A computer program product may include a computer-readable medium.

The code may be executed by one or more processors, such as one or more digital signal processors (DSPs), general purpose microprocessors, application specific integrated circuits (ASICs), arithmetic logic units (ALUs), field programmable logic arrays (FPGAs), or other equivalent integrated or discrete logic circuitry. Accordingly, the term “processor,” as used herein may refer to any of the foregoing structure or any other structure suitable for implementation of the techniques described herein. Also, the techniques could be fully implemented in one or more circuits or logic elements.

The techniques of this disclosure may be implemented in a wide variety of devices or apparatuses, including a wireless handset, an integrated circuit (IC) or a set of ICs, e.g., a chip set. Various components, modules or units are described in this disclosure to emphasize functional aspects of devices configured to perform the disclosed techniques, but do not necessarily need realization by different hardware units. Rather, as described above, various units may be combined in any hardware unit or provided by a collection of inter-operative hardware units, including one or more processors as described above, in conjunction with suitable software and/or firmware. Accordingly, the term “processor,” as used herein may refer to any of the foregoing structure or any other structure suitable for implementation of the techniques described herein. Also, the techniques may be fully implemented in one or more circuits or logic elements.

The following aspects are illustrative only and may be combined with other aspects or teachings described herein, without limitation.

Aspect 1 is an apparatus for graphics processing, including at least one memory and at least one processor coupled to the at least one memory and, based at least in part on information stored in the at least one memory, the at least one processor, individually or in any combination, is configured to: obtain an indication of a set of workloads; assign a first subset of the set of workloads to a first graphics pipeline and a second subset of the set of workloads to a second graphics pipeline; and render the first subset of the set of workloads in the first graphics pipeline and the second subset of the set of workloads in the second graphics pipeline.

Aspect 2 is the apparatus of aspect 1, wherein the first graphics pipeline is a binning render (BR) pipeline and the second graphics pipeline is a binning visibility (BV) pipeline, or wherein the first graphics pipeline is the BV pipeline and the second graphics pipeline is the BR pipeline.

Aspect 3 is the apparatus of any of aspects 1 to 2, wherein the at least one processor, individually or in any combination, is further configured to: change an assignment of at least one of (1) a portion of the first subset of the set of workloads to the second graphics pipeline or (2) a portion of the second subset of the set of workloads to the first graphics pipeline.

Aspect 4 is the apparatus of aspect 3, wherein the at least one processor, individually or in any combination, is further configured to: determine that at least one of (1) the portion of the first subset of the set of workloads is not to be rendered by the first graphics pipeline or (2) the portion of the second subset of the set of workloads is not to be rendered by the second graphics pipeline, wherein the change of assignment is based on the determination.

Aspect 5 is the apparatus of aspect 4, wherein the determination is based on at least one of the first graphics pipeline being idle or the second graphics pipeline being idle.

Aspect 6 is the apparatus of any of aspects 3 to 5, wherein the at least one processor, individually or in any combination, is further configured to: output an indication of the change of assignment of at least one of (1) the portion of the first subset of the set of workloads to the second graphics pipeline or (2) the portion of the second subset of the set of workloads to the first graphics pipeline.

Aspect 7 is the apparatus of aspect 6, wherein to output the indication of the change of assignment, the at least one processor, individually or in any combination, is configured to: output the indication of the change of assignment via a visibility stream in a graphics pipeline.

Aspect 8 is the apparatus of any of aspects 1 to 7, wherein the at least one processor, individually or in any combination, is further configured to: allocate a first resource for the first subset of the set of workloads and a second resource for the second subset of the set of workloads; and store first data associated with the first subset of the set of workloads in the first resource and second data associated with the second subset of the set of workloads in the second resource.

Aspect 9 is the apparatus of aspect 8, wherein the first data is distinct from the second data, and wherein the allocation of the first resource and the second resource is based on the first data being distinct from the second data.

Aspect 10 is the apparatus of any of aspects 8 to 9, wherein to store the first data associated with the first subset of the set of workloads in the first resource and the second data associated with the second subset of the set of workloads in the second resource, the at least one processor, individually or in any combination, is configured to: concurrently store the first data associated with the first subset of the set of workloads in the first resource and the second data associated with the second subset of the set of workloads in the second resource.

Aspect 11 is the apparatus of any of aspects 8 to 10, wherein the first resource is a first depth buffer and the second resource is a second depth buffer.

Aspect 12 is the apparatus of aspect 11, wherein the first depth buffer and the second depth buffer are cleared prior to the storage of the first data associated with the first subset of the set of workloads in the first depth buffer and the second data associated with the second subset of the set of workloads in the second depth buffer.

Aspect 13 is the apparatus of any of aspects 1 to 12, wherein a first portion of the first graphics pipeline and a second portion of the second graphics pipeline overlap at a shared graphics pipeline.

Aspect 14 is the apparatus of aspect 13, wherein the shared graphics pipeline is a pixel pipeline, and wherein the set of workloads is a set of depth-only workloads.

Aspect 15 is the apparatus of any of aspects 1 to 14, wherein the set of workloads comprises a set of depth pass workloads, and wherein the assignment is based on a change in a depth direction for the set of depth pass workloads.

Aspect 16 is the apparatus of any of aspects 1 to 15, wherein the assignment is based on at least one of: the set of workloads being associated with an occlusion query, a stencil being enabled, a depth test direction change, a memory space size limit, a set of mapping table entries, a depth buffer load, a single primitive mode, or a bin rendering mode.

Aspect 17 is the apparatus of any of aspects 1 to 16, wherein the at least one processor, individually or in any combination, is further configured to: determine that at least one of (1) a portion of the first subset of the set of workloads has already been rendered in the second graphics pipeline or (2) a portion of the second subset of the set of workloads has already been rendered in the first graphics pipeline; and refrain from rendering at least one of (1) the portion of the first subset of the set of workloads or (2) the portion of the second subset of the workloads in the second graphics pipeline based on the determination.

Aspect 18 is the apparatus of any of aspects 1 to 17, wherein to assign the first subset of the set of workloads to the first graphics pipeline and the second subset of the set of workloads to the second graphics pipeline, the at least one processor, individually or in any combination, is configured to: map the first subset of the set of workloads to the first graphics pipeline and the second subset of the set of workloads to the second graphics pipeline.

Aspect 19 is the apparatus of any of aspects 1 to 18, wherein the at least one processor, individually or in any combination, is further configured to: output an indication of the rendered first subset of the set of workloads and the rendered second subset of the set of workloads.

Aspect 20 is the apparatus of aspect 19, wherein to output the indication of the rendered first subset of the set of workloads and the rendered second subset of the set of workloads, the at least one processor, individually or in any combination, is configured to: transmit the indication of the rendered first subset of the set of workloads and the rendered second subset of the set of workloads; or store the indication of the rendered first subset of the set of workloads and the rendered second subset of the set of workloads.

Aspect 21 is the apparatus of aspect 20, wherein the apparatus is a wireless communication device, further including (i.e., comprising) at least one of an antenna or a transceiver coupled to the processor, wherein to transmit the indication of the rendered first subset of the set of workloads and the rendered second subset of the set of workloads, the at least one processor, individually or in any combination, is configured to: transmit, via at least one of the antenna or the transceiver, the indication of the rendered first subset of the set of workloads and the rendered second subset of the set of workloads.

Aspect 22 is a method of graphics processing for implementing any of aspects 1 to 21.

Aspect 23 is an apparatus for graphics processing including means for implementing any of aspects 1 to 21.

Aspect 24 is a computer-readable medium (e.g., a non-transitory computer-readable medium) storing computer executable code (e.g., code for graphics processing), the code when executed by a processor causes the processor to implement any of aspects 1 to 21.

What is claimed is:

1. An apparatus for graphics processing, comprising:
at least one memory; and
at least one processor coupled to the at least one memory and, based at least in part on information stored in the at least one memory, the at least one processor, individually or in any combination, is configured to:
obtain an indication of a set of workloads;
assign a first subset of the set of workloads to a first graphics pipeline and a second subset of the set of workloads to a second graphics pipeline; and
render the first subset of the set of workloads in the first graphics pipeline and the second subset of the set of workloads in the second graphics pipeline.

2. The apparatus of claim 1, wherein the first graphics pipeline is a binning render (BR) pipeline and the second graphics pipeline is a binning visibility (BV) pipeline, or
wherein the first graphics pipeline is the BV pipeline and the second graphics pipeline is the BR pipeline.

3. The apparatus of claim 1, wherein the at least one processor, individually or in any combination, is further configured to:
change an assignment of at least one of (1) a portion of the first subset of the set of workloads to the second graphics pipeline or (2) a portion of the second subset of the set of workloads to the first graphics pipeline.

4. The apparatus of claim 3, wherein the at least one processor, individually or in any combination, is further configured to:
determine that at least one of (1) the portion of the first subset of the set of workloads is not to be rendered by the first graphics pipeline or (2) the portion of the second subset of the set of workloads is not to be rendered by the second graphics pipeline, wherein the change of assignment is based on the determination.

5. The apparatus of claim 4, wherein the determination is based on at least one of the first graphics pipeline being idle or the second graphics pipeline being idle.

6. The apparatus of claim 3, wherein the at least one processor, individually or in any combination, is further configured to:
output an indication of the change of assignment of at least one of (1) the portion of the first subset of the set of workloads to the second graphics pipeline or (2) the portion of the second subset of the set of workloads to the first graphics pipeline.

7. The apparatus of claim 6, wherein to output the indication of the change of assignment, the at least one processor, individually or in any combination, is configured to:
output the indication of the change of assignment via a visibility stream in a graphics pipeline.

8. The apparatus of claim 1, wherein the at least one processor, individually or in any combination, is further configured to:
allocate a first resource for the first subset of the set of workloads and a second resource for the second subset of the set of workloads; and
store first data associated with the first subset of the set of workloads in the first resource and second data associated with the second subset of the set of workloads in the second resource.

9. The apparatus of claim 8, wherein the first data is distinct from the second data, and wherein the allocation of the first resource and the second resource is based on the first data being distinct from the second data.

10. The apparatus of claim 8, wherein to store the first data associated with the first subset of the set of workloads in the first resource and the second data associated with the second subset of the set of workloads in the second resource, the at least one processor, individually or in any combination, is configured to:
concurrently store the first data associated with the first subset of the set of workloads in the first resource and the second data associated with the second subset of the set of workloads in the second resource.

11. The apparatus of claim 8, wherein the first resource is a first depth buffer and the second resource is a second depth buffer, and wherein the first depth buffer and the second depth buffer are cleared prior to storage of the first data associated with the first subset of the set of workloads in the first depth buffer and the second data associated with the second subset of the set of workloads in the second depth buffer.

12. The apparatus of claim 1, wherein a first portion of the first graphics pipeline and a second portion of the second graphics pipeline overlap at a shared graphics pipeline, wherein the shared graphics pipeline is a pixel pipeline, and wherein the set of workloads is a set of depth-only workloads.

13. The apparatus of claim 1, wherein the set of workloads comprises a set of depth pass workloads, and wherein the assignment is based on a change in a depth direction for the set of depth pass workloads.

14. The apparatus of claim 1, wherein the assignment is based on at least one of:
the set of workloads being associated with an occlusion query,
a stencil being enabled,
a depth test direction change,
a memory space size limit,
a set of mapping table entries,
a depth buffer load,
a single primitive mode, or
a bin rendering mode.

15. The apparatus of claim 1, wherein the at least one processor, individually or in any combination, is further configured to:
determine that at least one of (1) a portion of the first subset of the set of workloads has already been rendered in the second graphics pipeline or (2) a portion of the second subset of the set of workloads has already been rendered in the first graphics pipeline; and
refrain from rendering at least one of (1) the portion of the first subset of the set of workloads or (2) the portion of the second subset of the workloads in the second graphics pipeline based on the determination.

16. The apparatus of claim 1, wherein to assign the first subset of the set of workloads to the first graphics pipeline and the second subset of the set of workloads to the second graphics pipeline, the at least one processor, individually or in any combination, is configured to:
map the first subset of the set of workloads to the first graphics pipeline and the second subset of the set of workloads to the second graphics pipeline.

17. The apparatus of claim 1, wherein the at least one processor, individually or in any combination, is further configured to:
output an indication of the rendered first subset of the set of workloads and the rendered second subset of the set of workloads.

18. The apparatus of claim 17, wherein to output the indication of the rendered first subset of the set of workloads and the rendered second subset of the set of workloads, the at least one processor, individually or in any combination, is configured to:
transmit the indication of the rendered first subset of the set of workloads and the rendered second subset of the set of workloads; or
store the indication of the rendered first subset of the set of workloads and the rendered second subset of the set of workloads.

19. A method of graphics processing, comprising:
obtaining an indication of a set of workloads;
assigning a first subset of the set of workloads to a first graphics pipeline and a second subset of the set of workloads to a second graphics pipeline; and
rendering the first subset of the set of workloads in the first graphics pipeline and the second subset of the set of workloads in the second graphics pipeline.

20. A computer-readable medium storing computer executable code for graphics processing, the code when executed by a processor causes the processor to:
obtain an indication of a set of workloads;
assign a first subset of the set of workloads to a first graphics pipeline and a second subset of the set of workloads to a second graphics pipeline; and
render the first subset of the set of workloads in the first graphics pipeline and the second subset of the set of workloads in the second graphics pipeline.
